(19) United States
(12) Patent Application Publication
(10) Pub. No.: US 2025/0071535 A1
(43) Pub. Date: Feb. 27, 2025

(54) ELECTRONIC DEVICE AND METHOD OF OPERATION THEREOF

(71) Applicant: Samsung Electronics Co., Ltd., Suwon-si (KR)

(72) Inventors: Daesung CHO, Suwon-si (KR); Taehwan SON, Suwon-si (KR); Sunghee JUNG, Suwon-si (KR); Suntae JOO, Suwon-si (KR)

(21) Appl. No.: 18/809,840

(22) Filed: Aug. 20, 2024

Related U.S. Application Data
(63) Continuation of application No. PCT/KR2024/011275, filed on Jul. 31, 2024.

(30) Foreign Application Priority Data
Aug. 21, 2023 (KR) 10-2023-0108828
Sep. 7, 2023 (KR) 10-2023-0119234

(51) Int. Cl. H04W 8/00; G06F 3/01

(52) U.S. Cl. CPC H04W 8/005; G06F 3/014

(57) ABSTRACT

An electronic device may include: memory configured to store a program including instructions, first communication circuitry configured to support a first communication scheme, second communication circuitry configured to support a second communication scheme, a display, and at least one controller comprising at least one processor, comprising processing circuitry. The instructions may, when executed by at least one processor, individually and/or collectively, cause the electronic device to: perform a scan for discovering an external device through the first communication circuitry; identify a plurality of external devices including a first wearable device, based on receiving of signals from the plurality of external devices, based on the scan; based on identifying the plurality of external devices, receive, from the first wearable device through the second communication circuitry, a first signal including identification information corresponding to the first wearable device; and display, through the display, a first screen indicating the first wearable device, based on the identification information included in the first signal corresponding to stored identification information.

### CROSS-REFERENCE TO RELATED APPLICATIONS

This application is a continuation of International Application No. PCT/KR2024/011275 designating the United States, filed on Jul. 31, 2024, in the Korean Intellectual Property Receiving Office and claiming priority to Korean Patent Application Nos. 10-2023-0108828, filed on Aug. 21, 2023, and 10-2023-0119234, filed on Sep. 7, 2023, in the Korean Intellectual Property Office, the disclosures of each of which are incorporated by reference herein in their entireties.

### BACKGROUND

### Field

The disclosure relates to an electronic device and an operation method thereof.

### Description of Related Art

In recent years, the use of wearable devices that can be worn by users has increased. To charge a wearable device or according to the user's intent, the user may temporarily detach the wearable device, and if multiple users are using the same or similar wearable devices in one space, the users may have difficulty in distinguishing their wearable devices from others.

In a case of wearable devices with displays (e.g., smart watches), the user is able to distinguish their wearable device from other people's wearable devices through the screens of the displays. However, in a case of wearable devices without displays (e.g., smart rings) or wearable devices (e.g., smart rings) with small displays, it may be hard to differentiate devices through the screens of the displays.

The information described above may be provided as a related art for helping understanding of the disclosure. No assertion or determination is made as to whether any of the contents described above could be applied as prior art related to the disclosure.

### SUMMARY

According to an example embodiment, an electronic device may include: memory configured to store a program including instructions, first communication circuitry configured to support a first communication scheme, second communication circuitry configured to support a second communication scheme, a display, and at least one controller comprising at least one processor comprising processing circuitry. The instructions may, when executed by at least one processor, individually and/or collectively, cause the electronic device to perform a scan for discovering an external device through the first communication circuitry. The instructions may, when executed by at least one processor, individually and/or collectively, cause the electronic device to identify a plurality of external devices including a first wearable device, based on receiving of signals from the plurality of external devices, based on the scan. The instructions may, when executed by at least one processor, individually and/or collectively, cause the electronic device to, based on identifying the plurality of external devices, receive, from the first wearable device through the second communication circuitry, a first signal including identification information corresponding to the first wearable device. The instructions may, when executed by at least one processor, individually and/or collectively, cause the electronic device to display, through the display, a first screen indicating the first wearable device, based on the identification information included in the first signal corresponding to stored identification information.

According to an example embodiment, a method of operating an electronic device may include: performing a scan for discovering an external device through a first communication scheme. The method may include identifying a plurality of external devices including a first wearable device, based on receiving of signals from the plurality of external devices, based on the scan. The method may include, based on identifying the plurality of external devices, receiving, from the first wearable device through a second communication scheme, a first signal including identification information corresponding to the first wearable device. The method may include displaying a first screen indicating the first wearable device, based on the identification information included in the first signal corresponding to stored identification information.

According to an example embodiment, a non-transitory computer-readable recording medium storing instructions which, when executed by at least one processor, individually and/or collectively, cause at least one operation to be performed by an electronic device, the at least one operation may include: performing a scan for discovering an external device through a first communication scheme. The at least one operation may include identifying a plurality of external devices including a first wearable device, based on receiving of signals from the plurality of external devices, based on the scan. The at least one operation may include based on identifying the plurality of external devices, receiving, from the first wearable device through a second communication scheme, a first signal including identification information corresponding to the first wearable device. The at least one operation may include displaying a first screen indicating the first wearable device, based on the identification information included in the first signal corresponding to stored identification information.

According to an example embodiment, an electronic device may include: memory configured to store a program including instructions, first communication circuitry configured to support a first communication scheme, second communication circuitry configured to support a second communication scheme, a display, and at least one controller including at least one processor, comprising processing circuitry. The instructions may, when executed by at least one processor, individually and/or collectively, cause the electronic device to perform a scan for discovering an external device through the first communication circuitry. The instructions may, when executed by at least one processor, individually and/or collectively, cause the electronic device to identify a first wearable device, based on receiving of a signal from the first wearable device, based on the scan. The instructions may, when executed by at least one processor, individually and/or collectively, cause the electronic device to receive, from the first wearable device through the first communication circuitry, a first signal including identification information corresponding to the first wearable device. The instructions may, when executed by at least one processor, individually and/or collectively, cause the electronic device to display, through the display, a first screen including a message for guiding of wearing of the first wearable device, based on the identification information included in the first signal corresponding to stored identification information. The instructions may, when executed by at least one processor, individually and/or collectively, cause the electronic device to display, through the display, a second screen indicating the first wearable device, based on not receiving a beacon signal from the first wearable device through the first communication circuitry for a specified period after displaying the first screen.

According to an example embodiment, a method of operating an electronic device may include: performing a scan for discovering an external device through a first communication scheme. The method may include identifying a first wearable device, based on receiving of a signal from the first wearable device, based on the scan. The method may include receiving, from the first wearable device through the first communication scheme, a first signal including identification information corresponding to the first wearable device. The method may include displaying a first screen including a message for guiding of wearing of the first wearable device, based on the identification information included in the first signal corresponding to stored identification information. The method may include displaying a second screen indicating the first wearable device, based on not receiving a beacon signal from the first wearable device through the first communication scheme for a specified period after displaying the first screen.

According to an example embodiment, a non-transitory computer-readable recording medium storing instructions, which when executed by at least one processor, individually and/or collectively, cause at least one operation to be performed by an electronic device, the at least one operation may include: performing a scan for discovering an external device through a first communication scheme. The at least one operation may include identifying a first wearable device, based on receiving of a signal from the first wearable device, based on the scan. The at least one operation may include receiving, from the first wearable device through the first communication scheme, a first signal including identification information corresponding to the first wearable device. The at least one operation may include displaying a first screen including a message for guiding of wearing of the first wearable device, based on the identification information included in the first signal corresponding to stored identification information. The at least one operation may include displaying a second screen indicating the first wearable device, based on not receiving a beacon signal from the first wearable device through the first communication scheme for a specified period after displaying the first screen.

According to an example embodiment, an electronic device may include: memory configured to store a program including instructions, first communication circuitry configured to support a first communication scheme, second communication circuitry configured to support a second communication scheme, a display, and at least one controller comprising at least one processor, comprising processing circuitry. The instructions may, when executed by at least one processor, individually and/or collectively, cause the electronic device to receive, from a first wearable device through the first communication circuitry, a signal including identification information corresponding to the first wearable device. The instructions may, when executed by at least one processor, individually and/or collectively, cause the electronic device to store the identification information corresponding to the first wearable device in the memory. The instructions may, when executed by at least one processor, individually and/or collectively, cause the electronic device to identify custom information corresponding to the first wearable device, based on an input. The instructions may, when executed by at least one processor, individually and/or collectively, cause the electronic device to transmit, to the first wearable device through the first communication circuitry, a signal including the custom information. The instructions may, when executed by at least one processor, individually and/or collectively, cause the electronic device to, in a state in which communication of the first communication scheme between the electronic device and the first wearable device is not established, perform a scan for discovering an external device through the first communication circuitry. The instructions may, when executed by at least one processor, individually and/or collectively, cause the electronic device to identify a plurality of external devices including the first wearable device, based on receiving of The instructions may, when executed by at least one processor, individually and/or collectively, cause the electronic device to, based on identifying the plurality of external devices, receive, from the first wearable device through the second communication circuitry, a first signal including the identification information and the custom information corresponding to the first wearable device. The instructions may, when executed by at least one processor, individually and/or collectively, cause the electronic device to display, through the display, a first screen indicating the first wearable device, based on the identification information included in the first signal corresponding to the identification information stored in the memory. The first screen may include the custom information corresponding to the first wearable device.

According to an example embodiment, a method of operating an electronic device may include: receiving, from a first wearable device through a first communication scheme, a signal including identification information corresponding to the first wearable device. The method may include storing the identification information corresponding to the first wearable device. The method may include identifying custom information corresponding to the first wearable device, based on an input. The method may include transmitting a signal including the custom information to the first wearable device through the first communication scheme. The method may include, in a state in which communication of the first communication scheme between the electronic device and the first wearable device is not established, performing a scan for discovering an external device through the first communication scheme. The method may include identifying a plurality of external devices including the first wearable device, based on receiving of signals from the plurality of external devices, based on the scan. The method may include, based on identifying the plurality of external devices, receiving, from the first wearable device through a second communication scheme, a first signal including the identification information and the custom information corresponding to the first wearable device. The method may include displaying a first screen indicating the first wearable device, based on the identification information included in the first signal corresponding to the identification information stored in the memory. The first screen may include the custom information corresponding to the first wearable device.

According to an example embodiment, a non-transitory computer-readable recording medium storing instructions that, when executed by at least one processor, individually and/or collectively, cause an electronic device to perform at least one operation, the at least one operation may include receiving, from a first wearable device through a first communication scheme, a signal including identification information corresponding to the first wearable device. The at least one operation may include storing the identification information corresponding to the first wearable device. The at least one operation may include identifying custom information corresponding to the first wearable device, based on an input. The at least one operation may include transmitting a signal including the custom information to the first wearable device through the first communication scheme. The at least one operation may include, in a state in which communication of the first communication scheme between the electronic device and the first wearable device is not established, performing a scan for discovering an external device through the first communication scheme. The at least one operation may include identifying a plurality of external devices including the first wearable device, based on receiving of signals from the plurality of external devices, based on the scan. The at least one operation may include, based on identifying the plurality of external devices, receiving, from the first wearable device through a second communication scheme, a first signal including the identification information and the custom information corresponding to the first wearable device. The at least one operation may include displaying a first screen indicating the first wearable device, based on the identification information included in the first signal corresponding to the identification information stored in the memory. The first screen may include the custom information corresponding to the first wearable device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example electronic device and wearable devices according to various embodiments;

FIG. 3A is a block diagram illustrating an example configuration of an electronic device and wearable devices according to various embodiments;

FIG. 3B is a diagram illustrating example communication according to various embodiments;

FIG. 4 is a diagram illustrating an example wearable device according to various embodiments;

FIG. 5A is a flowchart illustrating an example method of operating an electronic device according to various embodiments;

FIG. 5B is a flowchart illustrating an example method of operating an electronic device according to various embodiments;

FIG. 6A is a signal flow diagram illustrating an example method of operating an electronic device and a wearable device according to various embodiments;

FIG. 6B is a signal flow diagram illustrating an example method of operating an electronic device and a wearable device according to various embodiments;

FIG. 6C is a signal flow diagram illustrating an example method of operating an electronic device and a wearable device according to various embodiments;

FIG. 7 is a signal flow diagram illustrating an example method of operating an electronic device and a wearable device according to various embodiments;

FIG. 8A is a diagram illustrating an example operation of an electronic device according to various embodiments;

FIG. 8B is a diagram illustrating an example operation of an electronic device according to various embodiments;

FIG. 9 is a diagram illustrating an example operation of an electronic device according to various embodiments;

FIG. 10 is a signal flow diagram illustrating an example method of operating an electronic device and a wearable device according to various embodiments;

FIG. 11A is a diagram illustrating an example operation of an electronic device according to various embodiments;

FIG. 11B is a diagram illustrating an example operation of an electronic device according to various embodiments;

FIG. 12 is a signal flow diagram illustrating an example method of operating an electronic device and a wearable device according to various embodiments;

FIG. 13 is a signal flow diagram illustrating an example method of operating an electronic device and a wearable device according to various embodiments;

FIG. 14 is a signal flow diagram illustrating an example method of operating an electronic device and a wearable device according to various embodiments;

FIG. 15 is a diagram illustrating an example operation of an electronic device and a wearable device according to various embodiments;

FIG. 16 is a signal flow diagram illustrating an example method of operating an electronic device and a wearable device according to various embodiments; and

FIG. 17 is a diagram illustrating an example operation of an electronic device and a wearable device according to various embodiments.

### DETAILED DESCRIPTION

Hereinafter, various example embodiments of the disclosure will be described in greater detail with reference to the drawings. However, it will be understood that the disclosure may be implemented in any of various forms, and should not be construed as being limited to the various example embodiments set forth herein. In relation to the description of drawings, the same or similar elements may be indicated by the same or similar reference signs. In addition, in the drawings and related descriptions, description of well-known functions and configurations may be omitted of clarity and briefness.

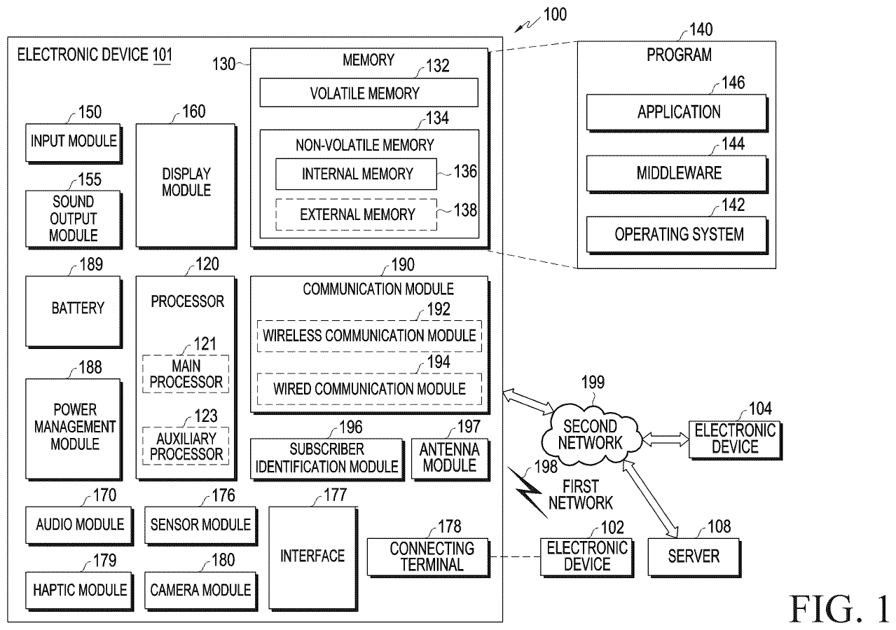

FIG. 1 is a block diagram illustrating an example electronic device in a network environment according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146. The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing 1eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

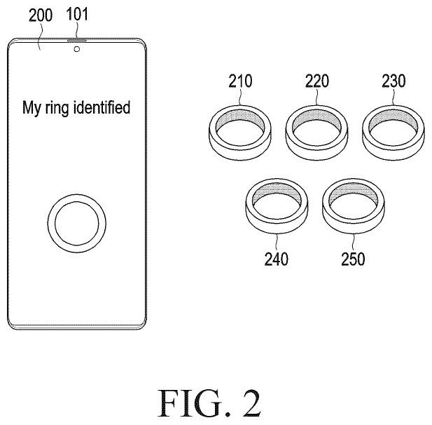

FIG. 2 is a diagram illustrating an example electronic device and wearable devices according to various embodiments.

With reference to embodiments of FIG. 2 and embodiments of the various drawings described below, an operation of identifying one wearable device (e.g., a wearable device 210 or 220) among multiple wearable devices 210, 220, 230, 240, and 250 using the electronic device 101 may be understood. For example, a wearable device (e.g., the wearable device 210, 220, 230, 240, or 250) of the disclosure may be a smart ring (e.g., an electronic device worn on a user's finger). However, a person skilled in the art may understand that embodiments of the disclosure are applicable to a wearable device (e.g., a smart watch, an activity tracker, smart glasses, a smart bracelet, smart shoes, a smart necklace, smart clothing, or a smart headband) other than a smart ring. Therefore, a smart ring merely corresponds to an example, and the following embodiments may also be applied to other wearable devices including at least some of the elements of a smart ring.

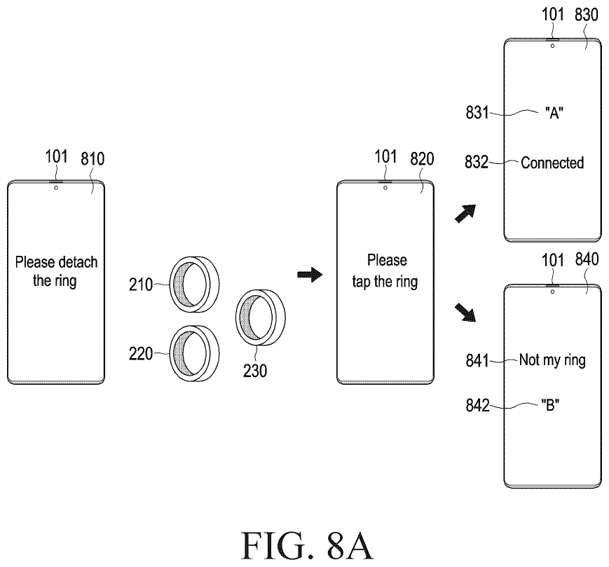

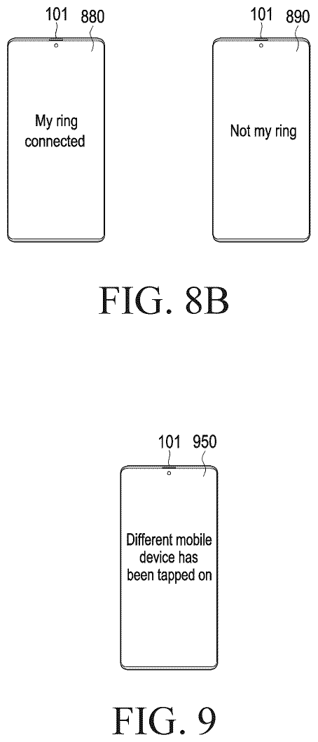

According to an embodiment, when the electronic device 101 and the multiple wearable devices 210, 220, 230, 240, and 250 are located in one space, the electronic device 101 may identify one wearable device (e.g., the wearable device 210 or 220) among the multiple wearable devices 210, 220, 230, 240, and 250. The wording “being located in one space” may imply being located in a physical one space or being located within a small distance in which the strength (e.g., received signal strength indicator (RSSI)) of a wireless signal is equal to or greater than a predetermined level. For example, the electronic device 101 may identify the first wearable device 210 registered in the electronic device 101 among the multiple wearable devices 210, 220, 230, 240, and 250. The electronic device 101 may display, through the display module 160, a screen (e.g., a screen 200 in FIG. 2, a screen 830 in FIG. 8A, or a screen 880 in FIG. 8B) indicating that a registered device has been identified, based on identifying the first wearable device 210 registered in the electronic device 101. For example, the electronic device 101 may identify the second wearable device 220 not registered in the electronic device 101 among the multiple wearable devices 210, 220, 230, 240, and 250. The electronic device 101 may display, through the display module 160, a screen (e.g., a screen 840 in FIG. 8A or a screen 890 in FIG. 8B) indicating that an unregistered device has been identified, based on identifying the second wearable device 220 not registered in the electronic device 101.

According to an embodiment, when the electronic device 101 and the first wearable device 210 are located in one space, the electronic device 101 may identify the first wearable device 210. For example, the electronic device 101 may identify whether the first wearable device 210 is a device registered in the electronic device 101 or a device not registered therein. The electronic device 101 may display, through the display module 160, a screen (e.g., the screen 200 in FIG. 2, the screen 830 in FIG. 8A, or the screen 880 in FIG. 8B) indicating that a registered device has been identified, or a screen (e.g., the screen 840 in FIG. 8A or the screen 890 in FIG. 8B) indicating that an unregistered device has been identified, based on identifying the first wearable device 210.

According to an embodiment, the electronic device 101 may identify identification information of a wearable device (e.g., the wearable device 210 or 220). The term “identification information” may refer, for example, to unique information (e.g., a Bluetooth (BT) name or a BT address) corresponding to a wearable device (e.g., the wearable device 210 or 220), and the type of identification information has no limit. The electronic device 101 may store the identification information of the first wearable device 210 in the memory 130. A device, the identification information of which is stored in the memory 130, may be referred to as a registered device. The electronic device 101 may compare identification information registered in the electronic device 101 with identification information received from a wearable device (e.g., the wearable device 210 or 220), thereby identifying whether the wearable device (e.g., the wearable device 210 or 220) is a registered device or an unregistered device. For example, the electronic device 101 may receive identification information from a wearable device (e.g., the wearable device 210 or 220) after storing the identification information of the first wearable device 210 in the memory 130. For example, as described below, the electronic device 101 may receive identification information of a wearable device (e.g., the wearable device 210 or 220), based on tapping of the wearable device (e.g., the wearable device 210 or 220) on the electronic device 101. Tapping may refer, for example, to two devices becoming close within a predetermined distance or two devices colliding with (or touching) each other. The electronic device 101 may compare the identification information received from the wearable device (e.g., the wearable or 130) with the identification information stored in the memory 130, thereby identifying whether the wearable device (e.g., the wearable device 210 or 220) is a registered device or an unregistered device. The electronic device 101 may display, through the display module 160, a screen (e.g., the screen 200 in FIG. 2, the screen 830 in FIG. 8A, or the screen 880 in FIG. 8B) indicating that a registered device has been identified, based on identifying the first wearable device 210. The electronic device 101 may display, through the display module 160, a screen (e.g., the screen 840 in FIG. 8A or the screen 890 in FIG. 8B) indicating that an unregistered device has been identified, based on identifying the second wearable device 220.

An embodiment in which the electronic device 101 uses custom information of a wearable device (e.g., the wearable device 210 or 220) is possible. An embodiment in which the electronic device 101 does not use custom information of a wearable device (e.g., the wearable device 210 or 220) is possible. In the following example embodiments, an embodiment using custom information and an embodiment not using custom information may have identical or similar operations, differing from each other only in that custom information is used or not used.

According to an embodiment, the electronic device 101 may identify custom information of a wearable device (e.g., the wearable device 210 or 220). The term “custom information” may refer, for example, to information (e.g., a nickname, image information, or non-fungible token (NFT)-related information) defined by a user to correspond to a wearable device (e.g., the wearable device 210 or 220), and the type of custom information has no limit. A user may designate custom information corresponding to the user's wearable device to distinguish the user's wearable device from other wearable devices. The electronic device 101 may display, through the display module 160, a screen (e.g., the screen 830 in FIG. 8A) indicating that a registered device has been identified, or a screen (e.g., the screen 840 in FIG. 8A) indicating that an unregistered device has been identified, based on identifying a wearable device (e.g., the wearable device 210 or 220) by comparing identification information. The screen (e.g., the screen 830 in FIG. 8A) indicating that a registered device has been identified or the screen (e.g., the screen 840 in FIG. 8A) indicating that an unregistered device has been identified may include an object corresponding to custom information obtained by the electronic device 101. The user may know that who's wearable device has been identified by the electronic device 101, based on an object corresponding to custom information included in a screen of the electronic device 101. For example, in a case where an object corresponding to custom information is included in a screen (e.g., the screen 830 in FIG. 8A) indicating that a registered device has been identified, the user may know that the user's wearable device has been identified by the electronic device 101, based on the displayed object corresponding to custom information designated by the user. For example, in a case where an object corresponding to custom information is included in a screen (e.g., the screen 830 in FIG. 8A) indicating that a registered device has been identified, the user may know that another person's wearable device registered in the electronic device 101 has been identified by the electronic device 101, based on the displayed object not corresponding to custom information designated by the user. For example, in a case where an object corresponding to custom information is included in a screen (e.g., the screen 840 in FIG. 8A) indicating that an unregistered device has been identified, the user may know that the user's wearable device has not been registered in the electronic device 101, based on the displayed object corresponding to custom information designated by the user. For example, in a case where an object corresponding to custom information is included in a screen (e.g., the screen 840 in FIG. 8A) indicating that an unregistered device has been identified, the user may know that another person's wearable device not registered in the electronic device 101 has been identified by the electronic device 101, based on the displayed object not corresponding to custom information designated by the user.

According to an embodiment, the electronic device 101 may not identify custom information of a wearable device (e.g., the wearable device 210 or 220). In a case where the electronic device 101 does not identify custom information of a wearable device (e.g., the wearable device 210 or 220), a screen (e.g., the screen 880 in FIG. 8B) indicating that a registered device has been identified, or a screen (e.g., the screen 890 in FIG. 8B) indicating that an unregistered device has been identified may not include an object corresponding to custom information.

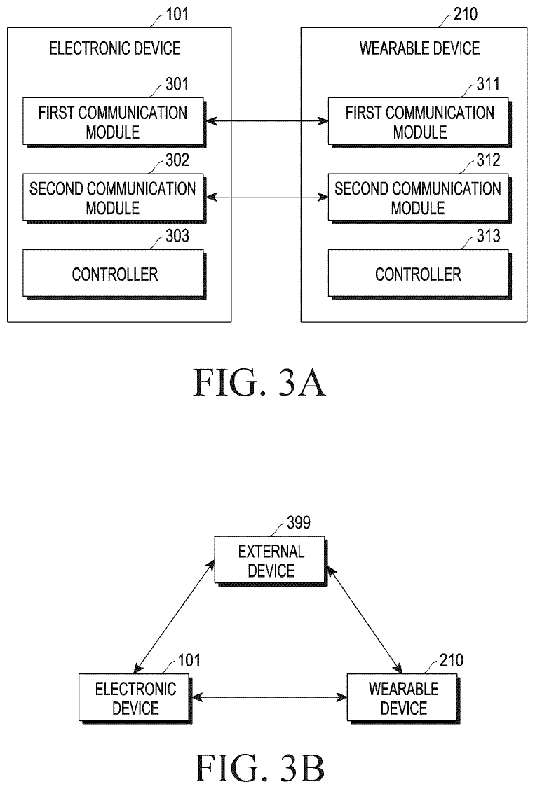

FIG. 3A is a block diagram illustrating an example configuration of an electronic device and a wearable device according to various embodiments. FIG. 3B is a diagram illustrating example communication according to various embodiments.

Referring to FIG. 3A, the electronic device 101 may include a first communication module (e.g., including communication circuitry) 301, a second communication module (e.g., including communication circuitry) 302, and a controller (e.g., including processing circuitry) 303. The controller 303 may correspond to the processor 120 illustrated in FIG. 1. There is no limit to the method of implementing the controller 303. An operation of the electronic device 101 according to an embodiment may be controlled by the controller 303 of the electronic device 101. The electronic device 101 performing a particular operation may indicate that the electronic device 101 or an element included in the electronic device 101 is controlled by the controller 303 of the electronic device 101. The electronic device 101 may include one or more controllers 303 (e.g., one or more controllers including the processor 120 in FIG. 1), and hereinafter, even in a case where the electronic device includes multiple controllers 303, “an operation of the electronic device 101” or “an operation of the controller 303” is used for convenience of explanation. For example, the electronic device 101 (e.g., the controller 303) may use the first communication module 301 and the second communication module 302 to identify the wearable device 210. The first communication module 301 and the second communication module 302 may be included in the communication module 190 illustrated in FIG. 1. The first communication module 301 may include various communication circuitry and be configured to support a first communication scheme. The second communication module 302 may include various communication circuitry and be configured to support a second communication scheme different from the first communication scheme. The first communication module 301 may include first communication circuitry 301 configured to support the first communication scheme. An operation of the first communication module 301 may be understood as an operation of the first communication circuitry 301. The second communication module 302 may include second communication circuitry 302 configured to support the second communication scheme. An operation of the second communication module 302 may be understood as an operation of the second communication circuitry 302. For example, each of the first communication module 301 and the second communication module 302 may be configured to support one communication scheme among Bluetooth, Bluetooth low energy (BLE), ZigBee, ANT+, Wi-Fi, cellular (LTE, 5G, 6G, or NB-IoT), near field communication (NFC), radio frequency identification (RFID), ultra-wideband (UWB), and global navigation satellite system (GNSS). The communication schemes merely correspond to an example, and there is no limit to the communication schemes supported by the first communication module 301 and the second communication module 302.

Referring to FIG. 3A, the wearable device 210 may include a first communication module 311, a second communication module 312, and a controller 313. An operation of the wearable device 210 according to an embodiment may be controlled by the controller 313 of the wearable device 210. The wearable device 210 performing a particular operation may indicate that the wearable device 210 or an element included in the wearable device 210 is controlled by the controller 313 of the wearable device 210. The controller 313 may include one or more processors. The controller 313 may be implemented as a system-on-chip type (SoC) by being integrated with a communication module or a sensor module. Hereinafter, even in a case where the wearable device includes multiple controllers 313, “an operation of the wearable device 210” or “an operation of the controller 313” is used for convenience of explanation. For example, the wearable device 210 (e.g., the controller 313) may use the first communication module 311 and the second communication module 312 to communicate with the electronic device 101. The first communication module 311 may be configured to support the first communication scheme. For example, the wearable device 210 (e.g., the controller 313) may use the first communication module 311 to communicate with the electronic device 101 (e.g., the first communication module 301 of the electronic device 101) through the first communication scheme. The second communication module 312 may be configured to support the second communication scheme different from the first communication scheme. The wearable device 210 (e.g., the controller 313) may use the second communication module 312 to communicate with the electronic device 101 (e.g., the second communication module 302 of the electronic device 101) through the second communication scheme. For example, each of the first communication module 311 and the second communication module 312 may be configured to support one communication scheme among Bluetooth, Bluetooth low energy (BLE), ZigBee, ANT+, Wi-Fi, cellular (LTE, 5G, 6G, or NB-IoT), near field communication (NFC), radio frequency identification (RFID), ultra-wideband (UWB), and global navigation satellite system (GNSS). The communication schemes merely correspond to an example, and there is no limit to the communication schemes supported by the first communication module 311 and the second communication module 312. According to a communication scheme (e.g., one communication scheme among Bluetooth, Bluetooth low energy (BLE), ZigBee, ANT+, Wi-Fi, cellular (LTE, 5G, 6G, or NB-IoT), near field communication (NFC), radio frequency identification (RFID), ultra-wideband (UWB), and global navigation satellite system (GNSS)) supported by a communication module (e.g., the communication modules 301 and 311 or the communication modules 302 and 312), a communication module (e.g., the communication module 301 or 302) of the electronic device 101 and a communication module (e.g., the communication module 311 or 312) of the wearable device 210 may be implemented as a symmetric or asymmetric type. In the symmetric type, for example, in BLE communication, the electronic device 101 and the wearable device 210 may include the same communication module. In the asymmetric type, for example, in NFC communication or UWB communication, the electronic device 101 may include a communication module operating as a leader or an anchor, and the wearable device 210 may include a communication module operating as a tag.

Further, as described above, the controller 303 and/or 313 may include at least one processor. The controllers 303, 313 may each include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

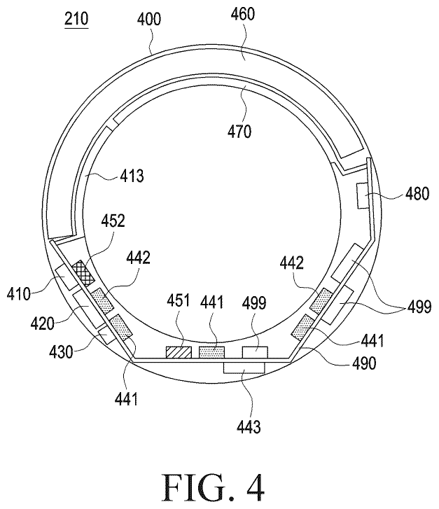

Referring to FIG. 3B, the electronic device 101 may perform direct communication with the wearable device 210 as illustrated in FIG. 3A. Referring to FIG. 3B, according to an embodiment, the electronic device 101 and the wearable device 210 may perform communication through an external device 399 (e.g., an access point, a base station, or a server) using a communication module (e.g., the communication modules 301 and 311 or the communication modules 302 and 312) according to a communication scheme (e.g., one communication scheme among Bluetooth, Bluetooth low energy (BLE), ZigBee, ANT+, Wi-Fi, cellular (LTE, 5G, 6G, or NB-IoT), near field communication (NFC), radio frequency identification (RFID), ultra-wideband (UWB), and global navigation satellite system (GNSS)) supported by the communication module (e.g., the communication modules 301 and 311 or the communication modules 302 and 312). FIG. 4 is a diagram illustrating an example configuration of a wearable device according to various embodiments.

An arrangement of elements of the wearable device 210 illustrated in FIG. 4 merely corresponds to an example. The elements of the wearable device 210 may be arranged differently from those of FIG. 4.

According to an embodiment, the wearable device 210 may include a housing (e.g., a housing 400). Referring to FIG. 4, the housing 400 of the wearable device 210 may have a form of a ring. The housing 400 may have a shape having a hole in the center. The housing 400 may include an external housing and an internal housing. The external housing of the housing 400 may be made of a material, such as titanium, stainless, or ceramic, which is able to withstand external impacts and scratches and implement design features. The external housing of the housing 400 may be processed with an additional color or a coating. The internal housing of the housing 400 is a part with which a hand comes into contact when the wearable device is put on a finger, and may be configured of the same material as the external housing or using a material such as a molding material, transparent plastic, or glass for sensing. The internal housing of the housing 400 may be partially configured of a metallic material for biometric measurement.

According to an embodiment, the wearable device 210 may include a processor (e.g., a processor 420). Referring to FIG. 4, the processor 420 of FIG. 4 may be the controller 313 of FIG. 3A. For example, the processor 420 may be an application processor (AP), a supplementary processor (SP) (e.g., sensor hub), a central processor unit (CPU), a neural processor unit (NPU), a graphic processor unit (GPU), or an Internet-of-things (IoT) processor (e.g., a processor integrated with the communication modules 311 and/or 312). For example, the controller 313 may include one or more processors 420 (e.g., one or more processors among an AP, an SP, a CPU, an NPU, a GPU, or an IoT processor). The processor 420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the wearable device 210 may include a communication module including communication circuitry (e.g., a communication module 410). Referring to FIG. 4, the communication module 410 of FIG. 4 may include the first communication module 311 and the second communication module 312 of FIG. 3A. The communication module 410 may be integrated with the processor 420. For example, the first communication module 311 may be integrated with the processor 420. The second communication module 312 may be integrated with the processor 420. The first communication module 311 and the second communication module 312 may be configured separately from the processor 420.

According to an embodiment, the wearable device 210 may include an antenna (e.g., an antenna 413). The antenna 413 may be an antenna for wireless communication. The antenna 413 may include a single or multiple segmented antennas. Referring to FIG. 4, a part of the housing 400 of the wearable device 210 may be used as the antenna 413.

According to an embodiment, the wearable device 210 may include memory (e.g., memory 430). Referring to FIG. 4, the wearable device 210 may store data (e.g., sensing data or communication data) in the memory 430. The memory 430 may be integrated with the processor 420.

According to an embodiment, the wearable device 210 may include a photoplethysmography (PPG) sensor (e.g., a sensor indicated by reference numerals 441, 442, and 443). The PPG sensor (e.g., a sensor indicated by reference numerals 441, 442, and 443) may be a sensor that emits light to a human body and receives light absorbed, scattered, reflected thereby. The wearable device 210 may use the PPG sensor (e.g., a sensor indicated by reference numerals 441, 442, and 443) to identify a biometric signal. Referring to FIG. 4, at least one light emitter 441 of the PPG sensor may radiate light in various bands and may include an element, such as a light emitting diodes (LED), a laser, or a vertical cavity surface emitting laser (VCSEL). The band of the light emitter 441 may include green, read, and infrared (IR). At least one light receiver 442 of the PPG sensor may receive light reflected and/or transmitted after being emitted from the light emitter 441. A signal (e.g., light) obtained through the light receiver 442 may be converted through an analog-to-digital converter (ADC) and then be stored in the memory 430 or a sensor buffer. The light receiver 442 may include a photodiode (PD) or a complementary metal oxide semiconductor (CMOS). A control unit 443 of the PPG sensor may be an integrated circuit (IC) or an analog front end (AFE), control the light emitter 441 and the light receiver 442, process received data, and transmit the data to the processor 420 or store same in the memory 430.

According to an embodiment, the wearable device 210 may include an inertial sensor (e.g., an inertial sensor 451). The inertial sensor (e.g., the inertial sensor 451) may be a sensor, such as an accelerator sensor or a gyroscope, which detects inertia. Referring to FIG. 4, the inertial sensor 451 may include only an accelerator sensor (e.g., a 3-axis sensor), or include an accelerator sensor and a gyroscope (e.g., a 6-axis sensor). The wearable device 210 (e.g., the controller 313) may sense a motion, a gesture, an impact, a posture, and an activity (sedentary, moving, or sports) of the wearable device 210 using the inertial sensor 451.

According to an embodiment, the wearable device 210 may include a temperature sensor (e.g., a temperature sensor 452). The temperature sensor (e.g., a temperature sensor 452) may be a sensor that measures the temperature of a human body or a component. The temperature sensor (e.g., a temperature sensor 452) may be a contact type or a non-contact type according to the scheme thereof. A temperature value measured through the temperature sensor (e.g., a temperature sensor 452) may be stored in the memory 430 or transferred to the processor 420. The wearable device 210 (e.g., the controller 313) may estimate the temperature of a human body, estimate the temperature of the wearable device 210, or recognize the situation around the wearable device 210 using the temperature sensor (e.g., a temperature sensor 452).

According to an embodiment, the wearable device 210 may include a battery (e.g., a battery 460). The battery 460 may be a device that converts chemical energy into electrical energy and stores same to supply power to the wearable device 210. The battery 460 (e.g., a secondary battery) may be charged and discharged and may be variously configured according to the material thereof, such as a lithium-ion, mercury, or dry battery. Referring to FIG. 4, the battery 460 may include a battery pack 250 that is bent to correspond to the housing 400. The battery 460 may include multiple battery packs that do not bent. The battery 460 may include a bendable battery pack and an unbendable battery pack.

According to an embodiment, the wearable device 210 may include a charging circuit (e.g., a charging circuit 470). The charging circuit 470 may be configured to support a wired charging (e.g., terminal or pogo pin) and/or wireless charging (e.g., WPC or NFC) scheme for charging of the wearable device 210 (e.g., the battery 460). The wearable device 210 may charge the battery 460 through the charging circuit 470.

According to an embodiment, the wearable device 210 may include a power management module including power management circuitry (e.g., a power management module 480). The power management module 480 may be a module that manages the power of the wearable device 210. The wearable device 210 (e.g., the controller 313) may distribute and control power suitably for the processor 420 and a sensor (e.g., the sensors indicated by reference numerals 441, 442, 443, 451, and 452) through the power management module (e.g., the power management module 480).

According to an embodiment, the wearable device 210 may include a substrate (e.g., a substrate 490). For example, the substrate (e.g., the substrate 490) may be a flexible printed circuit board (FPCB). Referring to FIG. 4, various types of elements, such as the communication module 410, the processor 420, the memory 430, a sensor (e.g., the sensors indicated by reference numerals 441, 442, 443, 451, and 452), the battery 460, and the power management module 480, may be arranged on the substrate 490. The various types of elements arranged on the substrate 490 may be electrically connected to each other.

According to an embodiment, the wearable device 210 may include a sound output module, a haptic module, a light emitting module (e.g., light emitting diode (LED)), or other elements 499, each of which may include various circuitry, and these elements will be described in greater detail below.

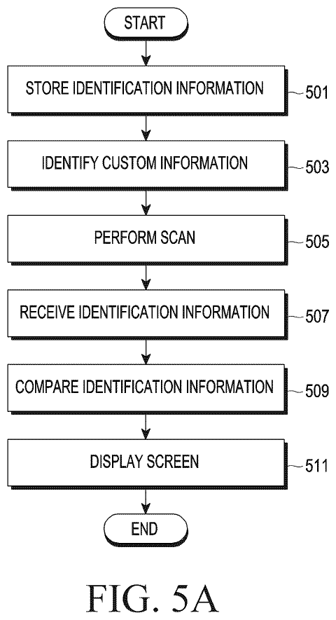

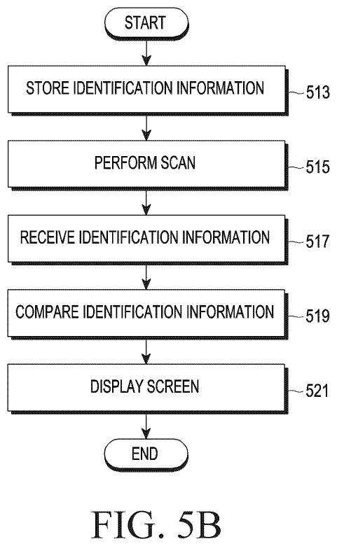

FIG. 5A is a flowchart illustrating an example method of operating an electronic device according to various embodiments. FIG. 5A may be described with reference to an embodiment described above.

At least some of operations illustrated in FIG. 5A may be omitted. The operation order of the operations illustrated in FIG. 5A may be changed. At least two operations among the operations illustrated in FIG. 5A may be performed in parallel. Before, during, or after performing the operations illustrated in FIG. 5A, an operation other than the operations of FIG. 5A may be performed.

Referring to FIG. 5A, an embodiment using custom information may be understood.

Referring to FIG. 5A, in operation 501, according to an embodiment, the electronic device 101 (e.g., the controller 303) may store identification information of the first wearable device 210. For example, the electronic device 101 may be connected to the first wearable device 210 through the first communication module 301 (e.g., a communication module supporting BLE communication). The electronic device 101 may obtain identification information (e.g., a BT name or BT address) of the first wearable device 210, based on a signal (e.g., a BLE advertisement signal) received from the first wearable device 210 through the first communication module 301 to enable connection to the first wearable device 210. The electronic device 101 may obtain identification information (e.g., a BT name or BT address) of the first wearable device 210, based on a signal (e.g., a BLE packet signal) received from the first wearable device 210 through the first communication module 301 after being connected to the first wearable device 210. The electronic device 101 may store the obtained identification information (e.g., a BT name or BT address) of the first wearable device 210 in the memory 130.

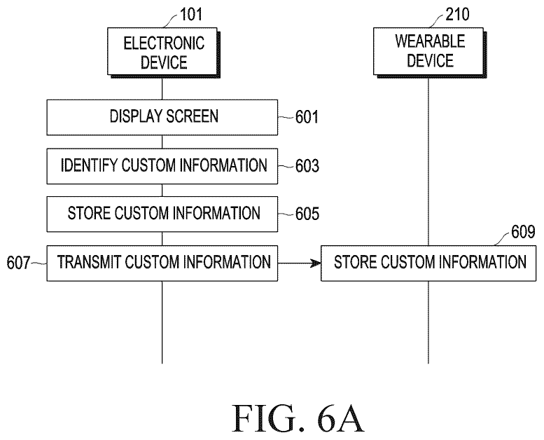

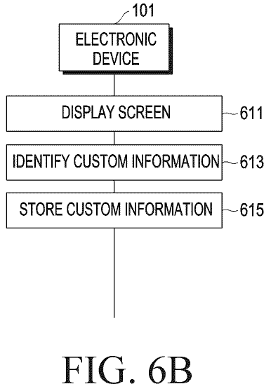

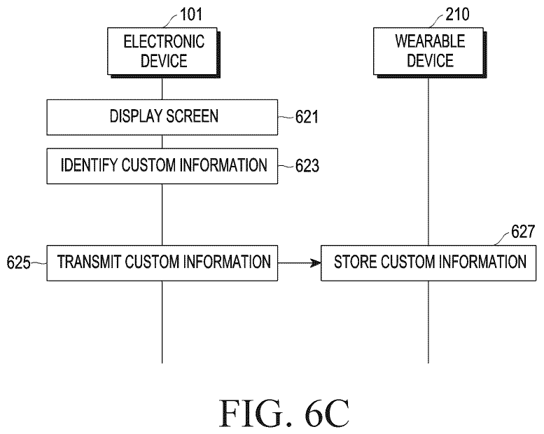

In operation 503, according to an embodiment, the electronic device 101 (e.g., the controller 303) may identify custom information of the first wearable device 210. The custom information may include a nickname, image information, or NFT-related information. The nickname may be a nickname of a wearable device (e.g., the wearable device 210 or 220) defined by the user. The image information may be an image itself or an address corresponding to the image. The NFT-related information may be information on a chain on which an NFT is issued, and/or the token number thereof. The operation of identifying custom information will be described later with reference to FIG. 6A, FIG. 6B, and FIG. 6C.

In operation 505, according to an embodiment, the electronic device 101 (e.g., the controller 303) may perform a scan for discovering an external device (e.g., the multiple wearable devices 210, 220, 230, 240, and 250) through the first communication module 301 (e.g., a communication module supporting BLE communication). For example, the electronic device 101 may perform a scan through the first communication module 301 while not being connected to the first wearable device 210 through the first communication module 301. The wording “scan” may refer, for example, to an operation of discovering, through the first communication module 301, a signal in a scan area (e.g., a designated frequency area) to receive a signal from the outside or an operation of receiving a signal from the outside. For example, the electronic device 101 may perform a scan for a scan area (e.g., a frequency area of a BLE advertisement signal) defined in the first communication scheme supported by the first communication module 301. The electronic device 101 may perform a scan for discovering an external device (e.g., the multiple wearable devices 210, 220, 230, 240, and 250) for a designated period. The electronic device 101 may identify a wearable device (e.g., the wearable device 210 or 220), based on receiving of a signal (e.g., a BLE advertisement signal) from the outside through the first communication module 301. For example, the electronic device 101 may, for the designated period, identify one wearable designated (e.g., the wearable device 210 or 220) or identify multiple wearable devices (e.g., the wearable devices 210, 220, 230, 240, and 250).

In operation 507, according to an embodiment, the electronic device 101 (e.g., the controller 303) may receive identification information from an external device (e.g., at least one device among the multiple wearable devices 210, 220, 230, 240, and 250). For example, the electronic device 101 may receive identification information (e.g., a BLE packet signal including identification information) from an external device (e.g., at least one device among the multiple wearable devices 210, 220, 230, 240, and 250) through the first communication module 301 (e.g., a communication module supporting BLE communication). For example, the electronic device 101 may receive identification information from an external device (e.g., at least one device among the multiple wearable devices 210, 220, 230, 240, and 250) through the second communication module 302 (e.g., a communication module supporting NFC communication), based on tapping of the external device on the electronic device 101. The electronic device 101 may receive custom information from an external device (e.g., at least one device among the multiple wearable devices 210, 220, 230, 240, and 250) together with or separately from identification information.

In operation 509, according to an embodiment, the electronic device 101 (e.g., the controller 303) may compare the identification information received in operation 507 with the identification information stored in operation 501.

In operation 511, according to an embodiment, the electronic device 101 (e.g., the controller 303) may display a screen through the display module 160, based on a result of the comparison between the pieces of identification information. According to an embodiment, the electronic device 101 may display a screen (e.g., the screen 830 in FIG. 8A) indicating that a registered device has been identified, based on the identification information received in operation 507 corresponding to the identification information stored in operation 501. The screen (e.g., the screen 830 in FIG. 8A) indicating that a registered device has been identified may include an object (e.g., an object 832 in FIG. 8A) indicating that a registered device has been identified. The screen (e.g., the screen 830 in FIG. 8A) indicating that a registered device has been identified may include an object (e.g., an object 831 in FIG. 8A) corresponding to the custom information of operation 503. The screen (e.g., the screen 830 in FIG. 8A) indicating that a registered device has been identified may include an object (e.g., the object 832 in FIG. 8A) indicating that a registered device has been identified and an object (e.g., the object 831 in FIG. 8A) corresponding to the custom information of operation 503. The screen indicating that a registered device has been identified may include only an object (e.g., a nickname, an image corresponding to image information, or an object corresponding to NFT information) corresponding to the custom information of operation 503. According to an embodiment, the electronic device 101 may display a screen (e.g., the screen 840 in FIG. 8A) indicating that an unregistered device has been identified, based on the identification information received in operation 507 not corresponding to the identification information stored in operation 501. The screen (e.g., the screen 840 in FIG. 8A) indicating that an unregistered device has been identified may include an object (e.g., an object 841 in FIG. 8A) indicating that an unregistered device has been identified. The screen (e.g., the screen 840 in FIG. 8A) indicating that an unregistered device has been identified may include an object (e.g., an object 842 in FIG. 8A) corresponding to custom information received, in operation 507, from an external device (e.g., at least one device among the multiple wearable devices 210, 220, 230, 240, and 250) together with or separately from identification information. The screen (e.g., the screen 840 in FIG. 8A) indicating that an unregistered device has been identified may include an object (e.g., the object 841 in FIG. 8A) indicating that an unregistered device has been identified and an object (e.g., the object 842 in FIG. 8A) corresponding to custom information received, in operation 507, from an external device (e.g., at least one device among the multiple wearable devices 210, 220, 230, 240, and 250) together with or separately from identification information. The screen indicating that an unregistered device has been identified may include only an object (e.g., e.g., a nickname, an image corresponding to image information, or an object corresponding to NFT information) corresponding to custom information received, in operation 507, from an external device (e.g., at least one device among the multiple wearable devices 210, 220, 230, 240, and 250) together with or separately from identification information.

FIG. 5B is a flowchart illustrating an example method of operating an electronic device according to various embodiments. FIG. 5B may be described with reference to an embodiment described above.

At least some of operations illustrated in FIG. 5B may be omitted. The operation order of the operations illustrated in FIG. 5B may be changed. At least two operations among the operations illustrated in FIG. 5B may be performed in parallel. Before, during, or after performing the operations illustrated in FIG. 5B, an operation other than the operations of FIG. 5B may be performed.

Referring to FIG. 5B, an embodiment not using custom information may be understood.

Referring to FIG. 5B, in operation 513, according to an embodiment, the electronic device 101 (e.g., the controller 303) may store identification information of the first wearable device 210. Operation 513 may be identical or similar to operation 501 of FIG. 5A, and an overlapped description may not be repeated here.

In operation 515, according to an embodiment, the electronic device 101 (e.g., the controller 303) may perform a scan for discovering an external device (e.g., the multiple wearable devices 210, 220, 230, 240, and 250) through the first communication module 301 (e.g., a communication module supporting BLE communication). Operation 515 may be identical or similar to operation 505 of FIG. 5A, and an overlapped description may not be repeated here.

In operation 517, according to an embodiment, the electronic device 101 (e.g., the controller 303) may receive identification information from an external device (e.g., at least one device among the multiple wearable devices 210, 220, 230, 240, and 250). Operation 517 may be identical or similar to operation 507 of FIG. 5A, and an overlapped description may not be repeated here.

In operation 519, according to an embodiment, the electronic device 101 (e.g., the controller 303) may compare the identification information received in operation 517 with the identification information stored in operation 513.

In operation 521, according to an embodiment, the electronic device 101 (e.g., the controller 303) may display a screen through the display module 160, based on a result of the comparison between the pieces of identification information. According to an embodiment, the electronic device 101 may display a screen (e.g., the screen 880 in FIG. 8B) indicating that a registered device has been identified, based on the identification information received in operation 517 corresponding to the identification information stored in operation 513. The screen (e.g., the screen 880 in FIG. 8B) indicating that a registered device has been identified may include an object (e.g., “My ring connected”) indicating that a registered device has been identified. According to an embodiment, the electronic device 101 may display a screen (e.g., the screen 890 in FIG. 8B) indicating that an unregistered device has been identified, based on the identification information received in operation 517 not corresponding to the identification information stored in operation 513. The screen (e.g., the screen 890 in FIG. 8B) indicating that an unregistered device has been identified may include an object (e.g., “Not my ring”) indicating that an unregistered device has been identified.

FIG. 6A is a is a signal flow diagram illustrating an example method of operating an electronic device and a wearable device according to various embodiments. FIG. 6B is a signal flow diagram illustrating an example method of operating an electronic device and a wearable device according to various embodiments. FIG. 6C is a signal flow diagram illustrating an example method of operating an electronic device and a wearable device according to various embodiments. FIG. 6A, 6B, and 6C may be described with reference to an embodiment described above.

The operation of identifying custom information may be understood with reference to FIG. 6A, 6B, and 6C.

At least some of operations illustrated in FIG. 6A may be omitted. The operation order of the operations illustrated in FIG. 6A may be changed. At least two operations among the operations illustrated in FIG. 6A may be performed in parallel. Before, during, or after performing the operations illustrated in FIG. 6A, an operation other than the operations of FIG. 6A may be performed.

Referring to FIG. 6A, in operation 601, according to an embodiment, the electronic device 101 (e.g., the controller 303) may display a screen for identifying custom information. For example, the electronic device 101 may display a screen for identifying custom information of the wearable device 210 while being connected to the wearable device 210 through the first communication module 301 (e.g., a communication module supporting BLE communication). A user may input custom information corresponding to the wearable device 210 through the screen for identifying custom information.

In operation 603, according to an embodiment, the electronic device 101 (e.g., the controller 303) may identify custom information corresponding to the wearable device 210 through the screen for identifying custom information, based on a user input. The electronic device 101 may receive an input of custom information (e.g., a nickname, image information, or NFT-related information) through the screen for identifying custom information.

In operation 605, according to an embodiment, the electronic device 101 (e.g., the controller 303) may store the custom information identified in operation 603 in the memory 130. The electronic device 101 may store, in the memory 130, information in which the custom information of the wearable device 210 and identification information of the wearable device 210 are mapped.

In operation 607, according to an embodiment, the electronic device 101 (e.g., the controller 303) may transmit the custom information to the wearable device 210. For example, the electronic device 101 may transmit the custom information identified in operation 603 to the wearable device 210 through the first communication module 301 (e.g., a communication module supporting BLE communication). For example, the electronic device 101 may transmit the information, in which the custom information of the wearable device 210 and the identification information of the wearable device 210 are mapped, to the wearable device 210 through the first communication module 301 (e.g., a communication module supporting BLE communication).

In operation 609, according to an embodiment, the wearable device 210 (e.g., the controller 313) may store the custom information received from the electronic device 101 in memory (e.g., the memory 430 in FIG. 4).

At least some of operations illustrated in FIG. 6B may be omitted. The operation order of the operations illustrated in FIG. 6B may be changed. At least two operations among the operations illustrated in FIG. 6B may be performed in parallel. Before, during, or after performing the operations illustrated in FIG. 6B, an operation other than the operations of FIG. 6B may be performed.

Referring to FIG. 6B, in operation 611, according to an embodiment, the electronic device 101 (e.g., the controller 303) may display a screen for identifying custom information. Operation 611 may be identical or similar to operation 601 of FIG. 6A, and an overlapped description may not be repeated here.

In operation 613, according to an embodiment, the electronic device 101 (e.g., the controller 303) may identify custom information corresponding to the wearable device 210 through the screen for identifying custom information, based on a user input. Operation 613 may be identical or similar to operation 603 of FIG. 6A, and an overlapped description may not be repeated here.

In operation 615, according to an embodiment, the electronic device 101 (e.g., the controller 303) may store the custom information identified in operation 613 in the memory 130. Operation 615 may be identical or similar to operation 605 of FIG. 6A, and an overlapped description may not be repeated here.

According to an embodiment, referring to FIG. 6B, the custom information may not be transmitted from the electronic device 101 to the wearable device 210.

At least some of operations illustrated in FIG. 6C may be omitted. The operation order of the operations illustrated in FIG. 6C may be changed. At least two operations among the operations illustrated in FIG. 6C may be performed in parallel. Before, during, or after performing the operations illustrated in FIG. 6C, an operation other than the operations of FIG. 6C may be performed.

Referring to FIG. 6C, in operation 621, according to an embodiment, the electronic device 101 (e.g., the controller 303) may display a screen for identifying custom information. Operation 621 may be identical or similar to operation 601 of FIG. 6A, and an overlapped description may not be repeated here.

In operation 623, according to an embodiment, the electronic device 101 (e.g., the controller 303) may identify custom information corresponding to the wearable device 210 through the screen for identifying custom information, based on a user input. Operation 623 may be identical or similar to operation 603 of FIG. 6A, and an overlapped description may not be repeated here.

In operation 625, according to an embodiment, the electronic device 101 (e.g., the controller 303) may transmit the custom information to the wearable device 210. For example, the electronic device 101 may transmit the custom information identified in operation 623 to the wearable device 210 through the first communication module 301 (e.g., a communication module supporting BLE communication). For example, the electronic device 101 may transmit information, in which the custom information of the wearable device 210 and identification information of the wearable device 210 are mapped, to the wearable device 210 through the first communication module 301 (e.g., a communication module supporting BLE communication).

In operation 627, according to an embodiment, the wearable device 210 (e.g., the controller 313) may store the custom information received from the electronic device 101 in memory (e.g., the memory 430 in FIG. 4).

According to an embodiment, referring to FIG. 6C, the custom information of the wearable device 210 may not be stored in the memory 130 of the electronic device 101.

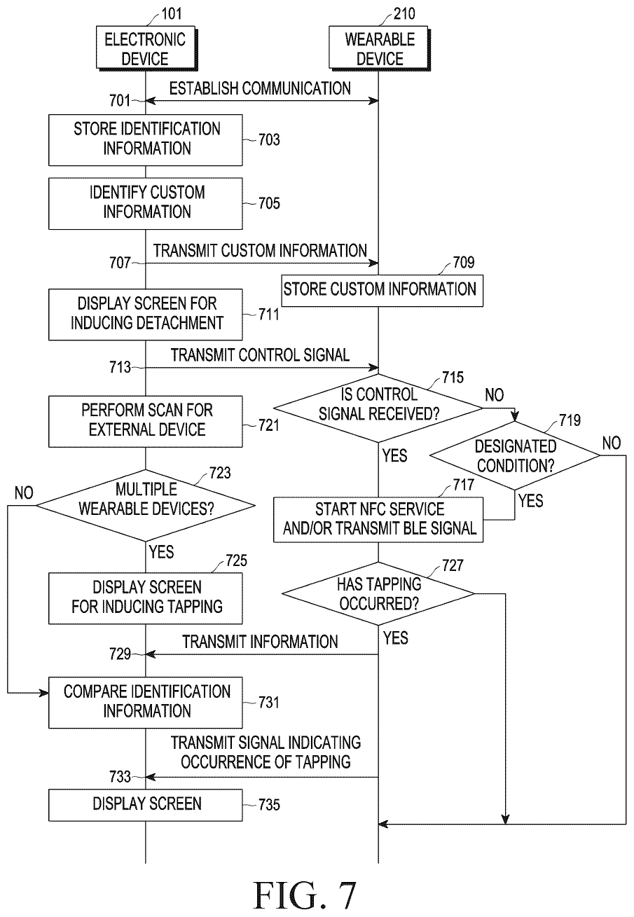

FIG. 7 is a signal flow diagram illustrating an example method of operating an electronic device and a wearable device according to various embodiments. FIG. 7 may be described with reference to an embodiment described above, and with reference to FIG. 8A, FIG. 8B, and FIG. 9. FIG. 8A is a diagram illustrating an example operation of an electronic device according to various embodiments. FIG. 8B is a diagram illustrating an example operation of an electronic device according to various embodiments. FIG. 9 is a diagram illustrating an example operation of an electronic device according to various embodiments.

At least some of operations illustrated in FIG. 7 may be omitted. The operation order of the operations illustrated in FIG. 7 may be changed. At least two operations among the operations illustrated in FIG. 7 may be performed in parallel. Before, during, or after performing the operations illustrated in FIG. 7, an operation other than the operations of FIG. 7 may be performed.

Referring to FIG. 7, in operation 701, according to an embodiment, the electronic device 101 (e.g., the controller 303) may establish a communication connection with the wearable device 210 through the first communication module 301 (e.g., a communication module supporting BLE communication).

In operation 703, according to an embodiment, the electronic device 101 (e.g., the controller 303) may store identification information of the wearable device 210. Operation 703 may be identical or similar to operation 501 of FIG. 5A or operation 513 of FIG. 5B, and an overlapped description may not be repeated here.

In operation 705, according to an embodiment, the electronic device 101 (e.g., the controller 303) may identify custom information corresponding to the wearable device 210 through a screen for identifying custom information, based on a user input. Operation 705 may be identical or similar to operation 503 of FIG. 5A, and an overlapped description may not be repeated here. Referring to the embodiment of FIG. 6A and the embodiment of FIG. 6B, the electronic device 101 (e.g., the controller 303) may store the identified custom information in the memory 130. Referring to the embodiment of FIG. 6C, the electronic device 101 (e.g., the controller 303) may not store the custom information. Referring to the embodiment of FIG. 5B, operation 705 may be omitted.

In operation 707, according to an embodiment, the electronic device 101 (e.g., the controller 303) may transmit the custom information to the wearable device 210. Operation 707 may be identical or similar to operation 607 of FIG. 6A or operation 625 of FIG. 6C, and an overlapped description may be omitted. Referring to the embodiment of FIG. 6B, operation 707 may be omitted.

In operation 709, according to an embodiment, the wearable device 210 (e.g., the controller 313) may store the custom information received from the electronic device 101 in memory (e.g., the memory 430 in FIG. 4). Referring to the embodiment of FIG. 5B and the embodiment of FIG. 6B, operation 709 may be omitted.

In operation 711, according to an embodiment, the electronic device 101 (e.g., the controller 303) may display a screen for inducing detachment. The screen for inducing detachment may be a screen including a message for guiding of detachment. For example, referring to FIG. 8A, the wearable device 210 may display, through the display module 160, a screen 810 including a message (e.g., “Please detach the ring”) for guiding of detachment. According to an embodiment, the wearable device 210 may be configured to transmit a signal through the first communication module 311 while the wearable device 210 is not worn by the user. The wearable device 210 may be configured to refrain from transmitting a signal through the first communication module 311 while the wearable device 210 is worn by the user. According to an embodiment, operation 711 may be omitted.

In operation 713, according to an embodiment, the electronic device 101 (e.g., the controller 303) may transmit a control signal to the wearable device 210 through the first communication module 301 (e.g., a communication module supporting BLE communication). The control signal of operation 713 may be a signal that causes the wearable device 210 to transmit a signal (e.g., BLE signal (e.g., BLE advertisement signal)) of the first communication scheme (e.g., BLE) and/or start a service of the second communication scheme (e.g., NFC). According to an embodiment, operation 713 may be omitted.

In operation 715, according to an embodiment, the wearable device 210 (e.g., the controller 313) may identify whether a control signal (e.g., the control signal of operation 713) has been received from the electronic device 101.

In operation 717, according to an embodiment, the wearable device 210 (e.g., the controller 313) may transmit a signal (e.g., BLE signal (e.g., BLE advertisement signal)) of the first communication scheme (e.g., BLE) and/or start a service of the second communication scheme (e.g., NFC), based on receiving of a control signal (e.g., the control signal of operation 713) from the electronic device 101. The wearable device 210 starting the service of the second communication scheme (e.g., NFC) may indicate the wearable device 210 entering a state where the wearable device 210 is able to transmit the identification information (and/or custom information) of the wearable device 210 through the second communication scheme (e.g., NFC).

In operation 719, according to an embodiment, the wearable device 210 (e.g., the controller 313) may identify whether a designated condition is satisfied, while a control signal (e.g., the control signal of operation 713) is not received from the electronic device 101. The designated condition may include a state where the wearable device 210 has been detached. The designated condition may include a state where the wearable device 210 is not being charged. The type of the designated condition has no limit. The satisfaction of the designated condition may be satisfaction of one condition or multiple conditions. According to an embodiment, the wearable device 210 may perform operation 717, based on identifying the satisfaction of the designated condition while a control signal (e.g., the control signal of operation 713) is not received from the electronic device 101. For example, the wearable device 210 may transmit a signal (e.g., BLE signal (e.g., BLE advertisement signal)) of the first communication scheme (e.g., BLE) and/or start a service of the second communication scheme (e.g., NFC), based on identifying the satisfaction of the designated condition while a control signal (e.g., the control signal of operation 713) is not received from the electronic device 101.

In operation 721, according to an embodiment, the electronic device 101 (e.g., the controller 303) may perform a scan for discovering an external device (e.g., the multiple wearable devices 210, 220, 230, 240, and 250) through the first communication module 301 (e.g., a communication module supporting BLE communication). Operation 721 may be identical or similar to operation 505 of FIG. 5A, and an overlapped description may not be repeated here. The electronic device 101 (e.g., the controller 303) may identify an external device (e.g., at least one device among the multiple wearable devices 210, 220, 230, 240, and 250), based on receiving of a signal (e.g., a BLE advertisement signal) from the outside through the first communication module 301.

In operation 723, according to an embodiment, the electronic device 101 (e.g., the controller 303) may perform operation 725, based on identifying multiple wearable devices (e.g., two or more of the multiple wearable devices 210, 220, 230, 240, 250) through operation 721. According to an embodiment, the electronic device 101 (e.g., the controller 303) may perform operation 731, based on identifying one wearable device (e.g., the wearable device 210 or 220) through operation 721.

In operation 725, according to an embodiment, the electronic device 101 (e.g., the controller 303) may display a screen for inducing tapping. The screen for inducing tapping may be a screen including a message for guiding of tapping. For example, referring to FIG. 8A, the wearable device 210 may display, through the display module 160, a screen 820 including a message (e.g., “Please tap the ring”) for guiding of tapping. According to an embodiment, operation 725 may be omitted.

In operation 727, according to an embodiment, the wearable device 210 (e.g., the controller 313) may transmit a signal (e.g., NFC signal), based on the occurrence of tapping. The wearable device 210 may transmit a signal (e.g., NFC signal) through the second communication module 312, based on the occurrence of tapping of the wearable device 210 on an external device (e.g., the electronic device 101 or a different electronic device).

In operation 729, according to an embodiment, the wearable device 210 (e.g., the controller 313) may transmit a signal (e.g., NFC signal) including identification information of the wearable device 210 to the electronic device 101 through the second communication module 312 (e.g., a communication module supporting NFC communication), based on the occurrence of tapping of the wearable device 210 on the electronic device 101. The wearable device 210 may transmit custom information to the electronic device 101 through the second communication module 312 (e.g., a communication module supporting NFC communication) together with or separately from the identification information. The electronic device 101 (e.g., the controller 303) may receive information (e.g., identification information) from the wearable device 210 through the second communication module 302. According to an embodiment, the electronic device 101 (e.g., the controller 303) may receive custom information from the wearable device 210 through the second communication module 302 together with or separately from the identification information. The electronic device 101 (e.g., the controller 303) may not receive custom information from the wearable device 210.

In operation 731, according to an embodiment, the electronic device 101 (e.g., the controller 303) may compare the identification information received from the wearable device 210 in operation 729 with the identification information stored in operation 703.

In operation 733, according to an embodiment, the wearable device 210 (e.g., the controller 313) may transmit a signal indicating occurrence of tapping through the first communication module 311 (e.g., a communication module supporting BLE communication), based on the occurrence of tapping of the wearable device 210 on an external device (e.g., the electronic device 101 or a different electronic device). According to an embodiment, operation 731 may be omitted.

In operation 735, according to an embodiment, the electronic device 101 (e.g., the controller 303) may display a screen, based on a result of operation 731. For example, the electronic device 101 may display a screen (e.g., the screen 830 in FIG. 8A) indicating the wearable device 210, based on the identification information received from the wearable device 210 in operation 729 corresponding to the identification information stored in operation 703. The screen (e.g., the screen 830 in FIG. 8A) indicating the wearable device 210 may be a screen (e.g., the screen 830 in FIG. 8A) indicating that a registered device has been identified. For example, the electronic device 101 may display a screen (e.g., the screen 830 in FIG. 8A) indicating that a registered device has been identified, based on the identification information received from the wearable device 210 in operation 729 corresponding to the identification information stored in operation 703. The screen (e.g., the screen 830 in FIG. 8A) indicating that a registered device has been identified may include an object (e.g., the object 832 in FIG. 8A) indicating that a registered device has been identified and/or an object (e.g., the object 831 in FIG. 8A) corresponding to the custom information of operation 705. For example, the electronic device 101 may display a screen (e.g., the screen 880 in FIG. 8B) indicating the wearable device 210, based on the identification information received from the wearable device 210 in operation 729 corresponding to the identification information stored in operation 703. The screen (e.g., the screen 880 in FIG. 8B) indicating the wearable device 210 may be a screen (e.g., the screen 880 in FIG. 8B) indicating that a registered device has been identified. For example, the electronic device 101 may display a screen (e.g., the screen 880 in FIG. 8A) indicating that a registered device has been identified, based on the identification information received from the wearable device 210 in operation 729 corresponding to the identification information stored in operation 703. The screen (e.g., the screen 880 in FIG. 8B) indicating that a registered device has been identified may include an object (e.g., “My ring connected”) indicating that a registered device has been identified. For example, the electronic device 101 may display a screen (e.g., the screen 840 in FIG. 8A) indicating that an unregistered device has been identified, based on the identification information received from the wearable device 210 in operation 729 not corresponding to the identification information stored in operation 703. The screen (e.g., the screen 840 in FIG. 8A) indicating that an unregistered device has been identified may be a screen indicating a different device (e.g., the different wearable device 220). The screen (e.g., the screen 840 in FIG. 8A) indicating that an unregistered device has been identified may include an object (e.g., the object 841 in FIG. 8A) indicating that an unregistered device has been identified and/or an object (e.g., the object 842 in FIG. 8B) corresponding to the custom information received in operation 729. For example, the electronic device 101 may display a screen (e.g., the screen 890 in FIG. 8B) indicating that an unregistered device has been identified, based on the identification information received from the wearable device 210 in operation 729 not corresponding to the identification information stored in operation 703. The screen (e.g., the screen 890 in FIG. 8B) indicating that an unregistered device has been identified may include an object (e.g., “Not my ring”) indicating that an unregistered device has been identified. For example, the electronic device 101 may display a screen (e.g., the screen 830 in FIG. 8A) indicating that a registered device has been identified, based on the identification information received from the wearable device 210 in operation 729 corresponding to the identification information stored in operation 703, and a signal being received in operation 733. The screen (e.g., the screen 830 in FIG. 8A) indicating that a registered device has been identified may include an object (e.g., the object 832 in FIG. 8A) indicating that a registered device has been identified and/or an object (e.g., the object 831 in FIG. 8A) corresponding to the custom information of operation 705. For example, the electronic device 101 may display a screen (e.g., the screen 880 in FIG. 8B) indicating that a registered device has been identified, based on the identification information received from the wearable device 210 in operation 729 corresponding to the identification information stored in operation 703, and a signal being received in operation 733. The screen (e.g., the screen 880 in FIG. 8B) indicating that a registered device has been identified may include an object (e.g., “My ring connected”) indicating that a registered device has been identified. For example, the electronic device 101 may display a screen (e.g., a screen 950 in FIG. 9) indicating that tapping of the wearable device 210 on a different device has been occurred, based on the signal of operation 733 being received while the information of operation 729 is not received. Referring to FIG. 9, the electronic device 101 may display the screen 950 including a message (e.g., “Different mobile device has been tapped on”) indicating that tapping of the wearable device 210 on a different device has been occurred, based on the signal of operation 733 being received while the information of operation 729 is not received.

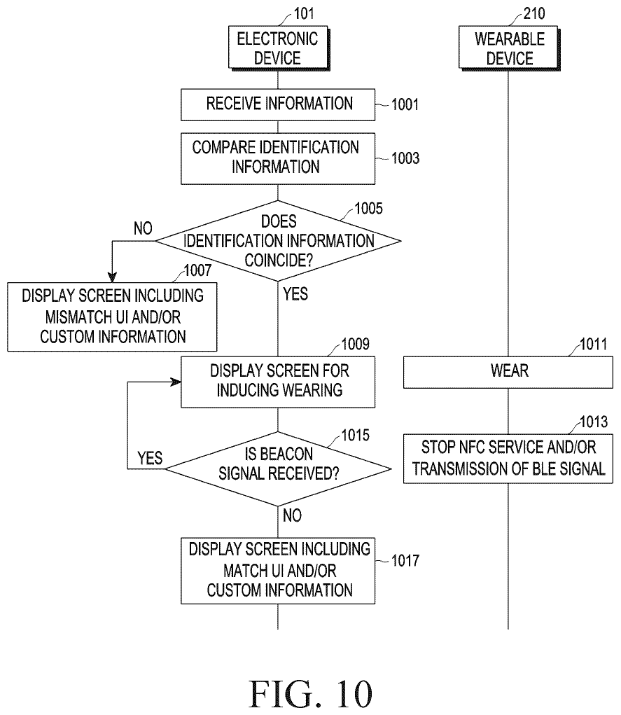

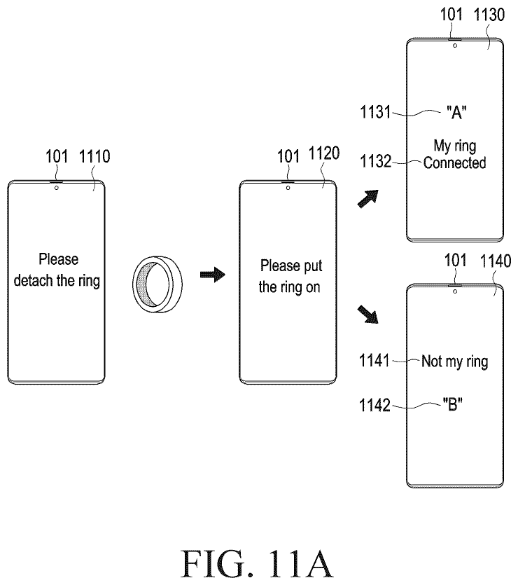

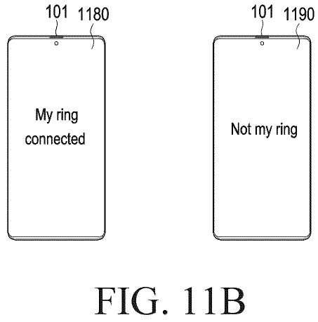

FIG. 10 is a signal flow diagram illustrating an example method of operating an electronic device and a wearable device according to various embodiments. FIG. 10 may be described with reference to an embodiment described above, and referring to FIG. 11A, and FIG. 11B. FIG. 11A is a diagram illustrating an example operation of an electronic device according to various embodiments. FIG. 11B is a diagram illustrating an example operation of an electronic device according to various embodiments.

At least some of operations illustrated in FIG. 10 may be omitted. The operation order of the operations illustrated in FIG. 10 may be changed. At least two operations among the operations illustrated in FIG. 10 may be performed in parallel. Before, during, or after performing the operations illustrated in FIG. 10, an operation other than the operations of FIG. 10 may be performed.

The operations of FIG. 10 may be performed after operation 723 FIG. 7.

Referring to FIG. 10, in operation 1001, according to an embodiment, the electronic device 101 (e.g., the controller 303) may receive information (e.g., identification information and/or custom information) from the wearable device 210. According to an embodiment, the electronic device 101 (e.g., the controller 303) may receive information (e.g., identification information and/or custom information) from the wearable device 210 through the first communication module 301. For example, the electronic device 101 (e.g., the controller 303) may receive information (e.g., identification information) from the wearable device 210 through the first communication module 301, after identifying one wearable device (e.g., the wearable device 210 or 220) in operation 723. According to an embodiment, the electronic device 101 (e.g., the controller 303) may receive information (e.g., identification information and/or custom information) from the wearable device 210 through the second communication module 302. For example, the electronic device 101 (e.g., the controller 303) may receive information (e.g., identification information) from the wearable device 210 through the second communication module 302, after identifying one wearable device (e.g., the wearable device 210 or 220) in operation 723. For example, the electronic device 101 (e.g., the controller 303) may receive information (e.g., identification information and/or custom information) from the wearable device 210 through the second communication module 302, after identifying multiple wearable devices (e.g., two or more of the multiple wearable devices 210, 220, 230, 240, 250) in operation 723 and performing operation 725. According to an embodiment, the electronic device 101 (e.g., the controller 303) may receive custom information from the wearable device 210 together with or separately from the identification information. The electronic device 101 (e.g., the controller 303) may not receive custom information from the wearable device 210.

In operation 1003, according to an embodiment, the electronic device 101 (e.g., the controller 303) may compare the identification information received in operation 1001 with stored identification information. Operation 1003 may be identical or similar to operation 731 of FIG. 7, and an overlapped description may be omitted.

In operation 1005, according to an embodiment, the electronic device 101 (e.g., the controller 303) may perform operation 1007, based on the pieces of identification information not coinciding each other. The electronic device 101 may perform operation 1009, based on the pieces of identification information coinciding each other.

In operation 1007, according to an embodiment, the electronic device 101 (e.g., the controller 303) may display a screen (e.g., 1140 in FIG. 11A or 1190 in FIG. 11B) including a mismatch UI (e.g., 1141 in FIG. 11A or “Not my ring” in FIG. 11B) and/or custom information (e.g., 1142 in FIG. 11A), based on the identification information received in operation 1001 not corresponding to the stored identification information.

In operation 1009, according to an embodiment, the electronic device 101 (e.g., the controller 303) may display a screen for inducing wearing, based on the identification information received in operation 1001 corresponding to the stored identification information. The screen for inducing wearing may be a screen including a message for guiding of wearing. For example, referring to FIG. 11A, the wearable device 210 may display, through the display module 160, a screen 1120 including a message (e.g., “Please put the ring on”) for guiding of wearing. According to an embodiment, the wearable device 210 may be configured to transmit a signal (e.g., BLE beacon signal) through the first communication module 311 while the wearable device 210 is not worn by the user. The wearable device 210 may be configured to refrain from transmitting a signal through the first communication module 311 while the wearable device 210 is worn by the user. In operation 1011, according to an embodiment, the wearable device 210 (e.g., the controller 313) may identify that the wearable device 210 has been put on by the user.

In operation 1013, according to an embodiment, the wearable device 210 (e.g., the controller 313) may stop transmitting a signal (e.g., BLE beacon signal)) of the first communication scheme (e.g., BLE) and/or stop a service of the second communication scheme (e.g., NFC), based on the wearable device 210 having been put on by the user.

In operation 1015, according to an embodiment, the electronic device 101 (e.g., the controller 303) may identify whether a beacon signal is received from the wearable device 210.

In operation 1017, according to an embodiment, the electronic device 101 (e.g., the controller 303) may display, through the display module 160, a screen (e.g., a screen 1130 in FIG. 11A or a screen 1180 in FIG. 11B) including a match UI (e.g., an object 1132 in FIG. 11A or “My ring connected” in FIG. 11B) and/or custom information (e.g., an object 1131 in FIG. 11A), based on not receiving a beacon signal from the wearable device 210 through the first communication module 301 for a designated period after displaying the screen of operation 1009.

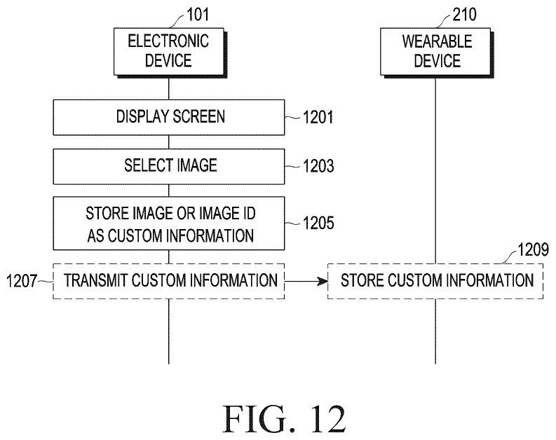

FIG. 12 is a signal flow diagram illustrating an example method of operating an electronic device and a wearable device according to various embodiments. FIG. 12 may be described with reference to an embodiment described above.

At least some of operations illustrated in FIG. 12 may be omitted. The operation order of the operations illustrated in FIG. 12 may be changed. At least two operations among the operations illustrated in FIG. 12 may be performed in parallel. Before, during, or after performing the operations illustrated in FIG. 12, an operation other than the operations of FIG. 12 may be performed.

Referring to FIG. 12, image information of custom information may be understood.

Referring to FIG. 12, in operation 1201, according to an embodiment, the electronic device 101 (e.g., the controller 303) may display a screen for identifying custom information corresponding to the wearable device 210. Operation 1201 may be identical or similar to operation 601 of FIG. 6A, and an overlapped description may be omitted.

In operation 1203, according to an embodiment, the electronic device 101 (e.g., the controller 303) may select an image, based on an input (e.g., a user input).

In operation 1205, according to an embodiment, the electronic device 101 (e.g., the controller 303) may store, as the custom information corresponding to the wearable device 210, the image itself or an image ID (e.g., an address corresponding to the image), based on operation 1203.

In operation 1207, according to an embodiment, the electronic device 101 (e.g., the controller 303) may transmit the custom information corresponding to the wearable device 210 to the wearable device 210. According to an embodiment, operation 1207 may be omitted.

In operation 1209, according to an embodiment, the wearable device 210 (e.g., the controller 313) may store the custom information received from the electronic device 101. According to an embodiment, operation 1209 may be omitted.

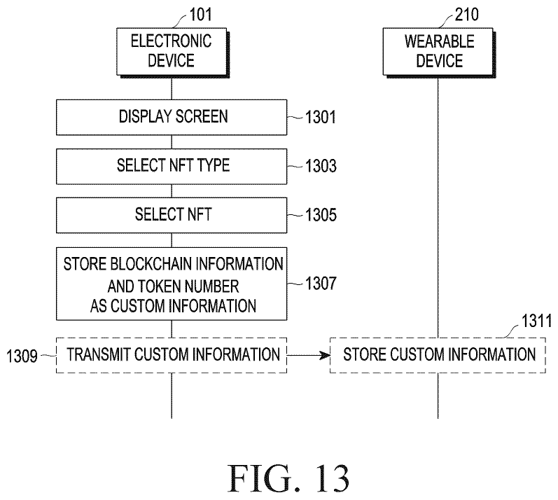

FIG. 13 is a signal flow diagram illustrating an example method of operating an electronic device and a wearable device according to various embodiments. FIG. 13 may be described with reference to an embodiment described above.

At least some of operations illustrated in FIG. 13 may be omitted. The operation order of the operations illustrated in FIG. 13 may be changed. At least two operations among the operations illustrated in FIG. 13 may be performed in parallel. Before, during, or after performing the operations illustrated in FIG. 13, an operation other than the operations of FIG. 13 may be performed.

Referring to FIG. 13, NFT information of custom information may be understood.

Referring to FIG. 13, in operation 1301, according to an embodiment, the electronic device 101 (e.g., the controller 303) may display a screen for identifying custom information corresponding to the wearable device 210. Operation 1301 may be identical or similar to operation 601 of FIG. 6A, and an overlapped description may not be repeated here.

In operation 1303, according to an embodiment, the electronic device 101 (e.g., the controller 303) may select an NFT type, based on an input (e.g., a user input).

In operation 1305, according to an embodiment, the electronic device 101 (e.g., the controller 303) may select an NFT in a blockchain wallet, based on a user input.

In operation 1307, according to an embodiment, the electronic device 101 (e.g., the controller 303) may store, as the custom information corresponding to the wearable device 210, blockchain information and a token number, based on operation 1303 and operation 1305.

In operation 1309, according to an embodiment, the electronic device 101 (e.g., the controller 303) may transmit the custom information corresponding to the wearable device 210 to the wearable device 210. According to an embodiment, operation 1309 may be omitted.

In operation 1311, according to an embodiment, the wearable device 210 (e.g., the controller 313) may store the custom information received from the electronic device 101. According to an embodiment, operation 1311 may be omitted.

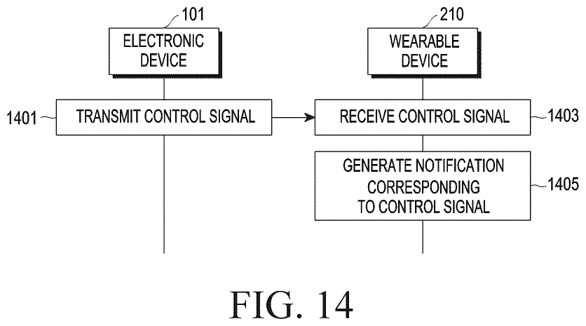

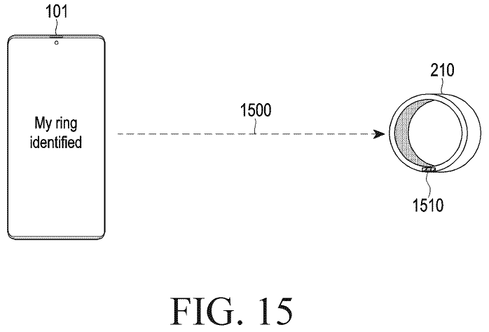

FIG. 14 is a a signal flow diagram illustrating an example method of operating an electronic device and a wearable device according to various embodiments. FIG. 14 may be described with reference to an embodiment described above and FIG. 15. FIG. 15 is a diagram illustrating an example operation of an electronic device according to various embodiments.

At least some of operations illustrated in FIG. 14 may be omitted. The operation order of the operations illustrated in FIG. 14 may be changed. At least two operations among the operations illustrated in FIG. 14 may be performed in parallel. Before, during, or after performing the operations illustrated in FIG. 14, an operation other than the operations of FIG. 14 may be performed.

Referring to FIG. 14, in operation 1401, according to an embodiment, the electronic device 101 (e.g., the controller 303) may transmit a control signal through the first communication module 301 (e.g., a communication module supporting BLE communication). The control signal of operation 1401 may be a signal that causes generation of a notification of the first wearable device 210. For example, the notification of the first wearable device 210 may be at least one of sound, vibration, and light generation.

In operation 1403, according to an embodiment, the wearable device 210 (e.g., the controller 313) may receive a control signal (e.g., a control signal 1500 in FIG. 15) (e.g., the control signal of operation 1401) from the electronic device 101 through the first communication module 311 (e.g., a communication module supporting BLE communication).

In operation 1405, according to an embodiment, the wearable device 210 (e.g., the controller 313) may generate a notification corresponding to a control signal (e.g., the control signal of operation 1401), based on receiving of the control signal from the electronic device 101. For example, referring to FIG. 15, the wearable device 210 may include a light emitting device 1510 (e.g., LED), and may generate a notification (e.g., light) corresponding to a control signal (e.g., the control signal of operation 1401), based on receiving of the control signal from the electronic device 101. For example, the wearable device 210 may include a haptic module or a sound output module, and may generate a notification (e.g., sound or vibration) corresponding to a control signal (e.g., the control signal of operation 1401), based on receiving of the control signal from the electronic device 101. The wearable device 210 may output the notification (e.g., light, sound, or vibration) corresponding to the control signal in a pattern designated by the user.

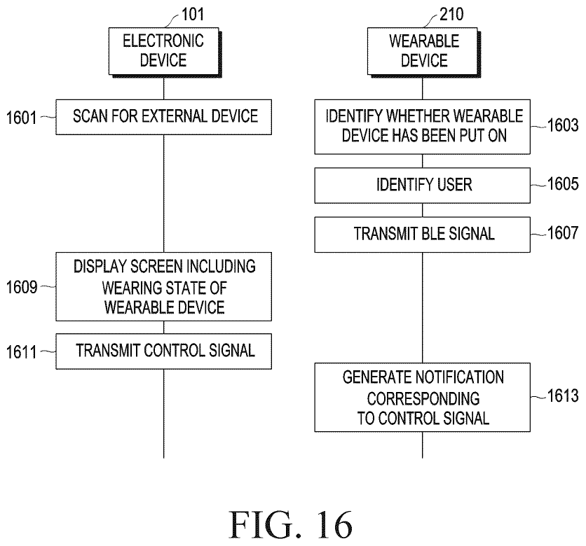

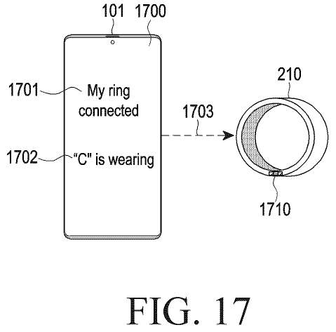

FIG. 16 is a signal flow diagram illustrating an example method of operating an electronic device and a wearable device according to various embodiments. FIG. 16 may be described with reference to an embodiment described above and FIG. 17. FIG. 17 is a diagram illustrating an example operation of an electronic device according to various embodiments.

At least some of operations illustrated in FIG. 16 may be omitted. The operation order of the operations illustrated in FIG. 16 may be changed. At least two operations among the operations illustrated in FIG. 16 may be performed in parallel. Before, during, or after performing the operations illustrated in FIG. 16, an operation other than the operations of FIG. 16 may be performed.

Referring to FIG. 16, in operation 1601, according to an embodiment, the electronic device 101 (e.g., the controller 303) may scan for an external device.

In operation 1603, according to an embodiment, the wearable device 210 (e.g., the controller 313) may identify whether the wearable device 210 has been put on, through a sensor (e.g., the sensors indicated by reference numerals 441, 442, 443, 451, and 452).

In operation 1605, according to an embodiment, the wearable device 210 (e.g., the controller 313) may identify a user wearing the wearable device 210 through fingerprint recognition or electrocardiogram (ECG) pattern recognition.

According to an embodiment, one of operation 1603 or operation 1605 may be omitted.

In operation 1607, according to an embodiment, the wearable device 210 (e.g., the controller 313) may transmit a signal (e.g., BLE signal) including information about a wearing state to the electronic device 101 through the first communication module 311 (e.g., a communication module supporting BLE communication). The information about the wearing state may include information identified in operation 1603 and/or information identified in operation 1605. The electronic device 101 (e.g., the controller 303) may receive a signal including information about a wearing state of the wearable device 210 through the first communication module 301 (e.g., a communication module supporting BLE communication).

In operation 1609, according to an embodiment, the electronic device 101 (e.g., the controller 303) may display a screen (e.g., a screen 1700 in FIG. 17) including the information about the wearing state of the wearable device 210. For example, referring to FIG. 17, the screen 1700 including the information about the wearing state of the wearable device 210 may include an object (e.g., “wearing” in an object 1702 in FIG. 17) indicating whether the wearable device 210 has been put on. For example, referring to FIG. 17, the screen 1700 including the information about the wearing state of the wearable device 210 may include an object (e.g., “C” in the object 1702 in FIG. 17) indicating a person wearing the wearable device 210. For example, referring to FIG. 17, the screen 1700 including the information about the wearing state of the wearable device 210 may include an object 1701 indicating whether the wearable device 210 is connected to the electronic device 101.

In operation 1611, according to an embodiment, the electronic device 101 (e.g., the controller 303) may transmit a control signal to the wearable device 210 through the first communication module 310, based on the signal received in operation 1607. The control signal of operation 1611 may be a signal that causes the wearable device 210 to generate a notification, based on the wearable device 210 being worn by a user rather than a registered user. The electronic device 101 may transmit the control signal of operation 1611 to the wearable device 210, based on the user wearing the wearable device 210, identified by the signal received in operation 1607, not corresponding to a user registered to correspond to the wearable device 210. The wearable device 210 may receive a control signal (e.g., a control signal 1703 in FIG. 17) from the electronic device 101 through the first communication module 311.

In operation 1613, according to an embodiment, the wearable device 210 (e.g., the controller 313) may generate a notification corresponding to the control signal of operation 1611. For example, referring to FIG. 17, the wearable device 210 may include a light emitting device 1710 (e.g., LED), and may generate a notification (e.g., light) corresponding to a control signal (e.g., the control signal of operation 1611), based on receiving of the control signal from the electronic device 101. For example, the wearable device 210 may include a haptic module or a sound output module, and may generate a notification (e.g., sound or vibration) corresponding to a control signal (e.g., the control signal of operation 1611), based on receiving of the control signal from the electronic device 101. The wearable device 210 may output the notification (e.g., light, sound, or vibration) corresponding to the control signal in a pattern designated by the user.

One skilled in the art may understand that various example embodiments disclosed herein may be applied interchangeably with each other in an applicable range. For example, one skilled in the art may understand that an embodiment disclosed herein may be applied without at least some operations thereof, and that embodiments may be applied while at least some operations thereof are connected.

Effects which are acquirable by the disclosure are not limited to the effects described above, and other effects that have not been mentioned may be clearly understood by one skilled in the art to which the disclosure belongs, from the following description.

According to an example embodiment, an electronic device may include: memory configured to store a program including instructions, first communication circuitry configured to support a first communication scheme, second communication circuitry configured to support a second communication scheme, a display, and at least one controller comprising at least one processor comprising processing circuitry. The instructions may, when executed by at least one processor, individually and/or collectively, cause the electronic device to: perform a scan for discovering an external device through the first communication circuitry; identify a plurality of external devices including a first wearable device, based on receiving of signals from the plurality of external devices, based on the scan; based on identifying the plurality of external devices, receive, from the first wearable device through the second communication circuitry, a first signal including identification information corresponding to the first wearable device; and display, through the display, a first screen indicating the first wearable device, based on the identification information included in the first signal corresponding to stored identification information.

According to an example embodiment, the instructions may, when executed by at least processor, individually and/or collectively, cause the electronic device to: before performing the scan, receive, from the first wearable device through the first communication circuitry, a signal including the identification information corresponding to the first wearable device; based on the signal, store the identification information corresponding to the first wearable device in the memory; wherein the stored identification information may include the identification information corresponding to the first wearable device stored in the memory.

According to an example embodiment, the instructions may, when executed by at least processor, individually and/or collectively, cause the electronic device to: before receiving the first signal, display, through the display, a second screen including a message for guiding tapping, based on identifying the plurality of external devices.

According to an example embodiment, the first signal may be transmitted, based on the tapping of the first wearable device on the electronic device.

According to an example embodiment, the instructions may, when executed by at least one processor, individually and/or collectively, cause the electronic device to: in a state in which the first signal has not been received from the first wearable device, receive, from the first wearable device through the first communication circuitry, a second signal indicating occurrence of tapping of the first wearable device;; based on the second signal, display, through the display, a third screen indicating tapping of the first wearable device on another external device.

According to an example embodiment, the instructions may, when executed by at least one processor, individually and/or collectively, cause the electronic device to: before performing the scan, identify custom information corresponding to the first wearable device, based on an input; store, in the memory, information in which the custom information and the identification information are mapped, wherein first screen may include the custom information corresponding to the first wearable device.

According to an example embodiment, the instructions may, when executed by at least one processor, individually and/or collectively, cause the electronic device to: in a state in which the first signal has not been received from the first wearable device, receive, from a second wearable device through the second communication circuitry, a third signal including identification information corresponding to the second wearable device;; and display, through the display, a fourth screen indicating another external device distinct from the first wearable device, based on the identification information included in the third signal not corresponding to the stored identification information.

According to an example embodiment, the instructions may, when executed by at least one processor, individually and/or collectively, cause the electronic device to: transmit a first control signal to the first wearable device through the first communication circuitry, before performing the scan for the external device; and based on the first control signal, transmit an advertisement signal of the first communication scheme and start a service of the second communication scheme.

According to an example embodiment, the first wearable device may be configured to transmit the advertisement signal of the first communication scheme and start the service of the second communication scheme, based on satisfaction of a specified condition while not receiving the first control signal.

According to an example embodiment, the instructions may, when executed by at least one processor, individually and/or collectively, cause the electronic device to: transmit, to the first wearable device through the first communication circuitry, a second control signal causing generation of a notification of the first wearable device, wherein the first wearable device may be configured to generate the notification corresponding to the second control signal.

According to an example embodiment, the first wearable device may be configured to transmit, to the electronic device, information about a wearing state of the first wearable device. The instructions may, when executed by at least one processor, individually and/or collectively, cause the electronic device to display, through the display, a fifth screen including the wearing state, based on the information about the wearing state.

According to an example embodiment, the first wearable device may comprise a smart ring.

According to an example embodiment, a method of operating an electronic device may include: performing a scan for discovering an external device through a first communication scheme; identifying a plurality of external devices including a first wearable device, based on receiving of signals from the plurality of external devices, based on the scan; based on identifying the plurality of external devices, receiving, from the first wearable device through a second communication scheme, a first signal including identification information corresponding to the first wearable device; and displaying a first screen indicating the first wearable device, based on the identification information included in the first signal corresponding to stored identification information.

According to an example embodiment, the method may include, before performing the scan, receiving, from the first wearable device through the first communication scheme, a signal including the identification information corresponding to the first wearable device; storing the identification information corresponding to the first wearable device, based on the signal, wherein the stored identification information may be the stored identification information corresponding to the first wearable device.

According to an example embodiment, the method may include, before receiving the first signal, displaying a second screen including a message for guiding of tapping, based on identifying the plurality of external devices.

According to an example embodiment, the first signal may be transmitted, based on the tapping of the first wearable device on the electronic device.

According to an example embodiment, the method may include, in a state in which the first signal has not been received from the first wearable device, receiving, from the first wearable device through the first communication scheme, a second signal indicating occurrence of tapping of the first wearable device. The method may include, based on the second signal, displaying a third screen indicating tapping of the first wearable device on another external device.

According to an example embodiment, the method may include, before performing the scan, identifying custom information corresponding to the first wearable device, based on an input. The method may include storing information in which the custom information and the identification information are mapped. The first screen may include the custom information corresponding to the first wearable device.

According to an example embodiment, the method may include, in a state in which the first signal has not been received from the first wearable device, receiving, from a second wearable device through the second communication scheme, a third signal including identification information corresponding to the second wearable device. The method may include displaying a fourth screen indicating another external device distinct from the first wearable device, based on the identification information included in the third signal not corresponding to the stored identification information.

According to an example embodiment, the method may include transmitting a first control signal to the first wearable device through the first communication scheme, before performing the scan for the external device. The first wearable device may be configured to, based on the first control signal, transmit an advertisement signal of the first communication scheme and start a service of the second communication scheme.

According to an example embodiment, the first wearable device may be configured to transmit the advertisement signal of the first communication scheme and start the service of the second communication scheme, based on satisfaction of a specified condition while not receiving the first control signal.

According to an example embodiment, the method may include transmitting, to the first wearable device through the first communication circuitry, a second control signal causing generation of a notification of the first wearable device. The first wearable device may be configured to generate the notification corresponding to the second control signal.

According to an example embodiment, the first wearable device may be configured to transmit, to the electronic device, information about a wearing state of the first wearable device. The method may include displaying a fifth screen including the wearing state, based on the information about the wearing state.

According to an example embodiment, the first wearable device may comprise a smart ring.

According to an example embodiment, a non-transitory computer-readable recording medium storing instructions which, when executed by at least one processor, individually and/or collectively, of an electronic device, cause the electronic device to perform at least one operation, the at least one operation comprising: performing a scan for discovering an external device through a first communication scheme; identifying a plurality of external devices including a first wearable device, based on receiving of signals from the plurality of external devices, based on the scan; based on identifying the plurality of external devices, receiving, from the first wearable device through a second communication scheme, a first signal including identification information corresponding to the first wearable device; and displaying a first screen indicating the first wearable device, based on the identification information included in the first signal corresponding to stored identification information.

According to an example embodiment, the at least one operation may include: before performing the scan, receiving, from the first wearable device through the first communication scheme, a signal including the identification information corresponding to the first wearable device; and storing the identification information corresponding to the first wearable device, based on the signal, wherein stored identification information may be the stored identification information corresponding to the first wearable device.

According to an example embodiment, the at least one operation may include, before receiving the first signal, displaying a second screen including a message for guiding of tapping, based on identifying the plurality of external devices.

According to an example embodiment, the first signal may be transmitted, based on the tapping of the first wearable device on the electronic device.

According to an example embodiment, the at least one operation may include in a state in which the first signal has not been received from the first wearable device, receiving, from the first wearable device through the first communication scheme, a second signal indicating occurrence of tapping of the first wearable device. The at least one operation may include, based on the second signal, displaying a third screen indicating tapping of the first wearable device on another external device.

According to an example embodiment, the at least one operation may include, before performing the scan, identifying custom information corresponding to the first wearable device, based on an input. The at least one operation may include storing information in which the custom information and the identification information are mapped. The first screen may include the custom information corresponding to the first wearable device.

According to an example embodiment, the at least one operation may include, in a state in which the first signal has not been received from the first wearable device, receiving, from a second wearable device through the second communication scheme, a third signal including identification information corresponding to the second wearable device. The at least one operation may include displaying a fourth screen indicating another external device distinct from the first wearable device, based on the identification information included in the third signal not corresponding to the stored identification information.

According to an example embodiment, the at least one operation may include transmitting a first control signal to the first wearable device through the first communication scheme, before performing the scan for the external device. The first wearable device may be configured to, based on the first control signal, transmit an advertisement signal of the first communication scheme and start a service of the second communication scheme.

According to an example embodiment, the first wearable device may be configured to transmit the advertisement signal of the first communication scheme and start the service of the second communication scheme, based on satisfaction of a specified condition while not receiving the first control signal.

According to an example embodiment, the at least one operation may include transmitting, to the first wearable device through the first communication circuitry, a second control signal causing generation of a notification of the first wearable device. The first wearable device may be configured to generate the notification corresponding to the second control signal.

According to an example embodiment, the first wearable device may be configured to transmit, to the electronic device, information about a wearing state of the first wearable device. The at least one operation may include displaying a fifth screen including the wearing state, based on the information about the wearing state.

According to an example embodiment, the first wearable device may comprise a smart ring.

According to an example embodiment, an electronic device may include: memory configured to store a program including instructions, first communication circuitry configured to support a first communication scheme, second communication circuitry configured to support a second communication scheme, a display, and at least one controller comprising at least one processor, comprising processing circuitry, wherein the instructions may, when executed by at least one controller processor, individually and/or collectively, cause the electronic device to: perform a scan for discovering an external device through the first communication circuitry; identify a first wearable device, based on receiving of a signal from the first wearable device 210, based on the scan; receive, from the first wearable device through the first communication circuitry, a first signal including identification information corresponding to the first wearable device; display, through the display, a first screen including a message for guiding of wearing of the first wearable device, based on the identification information included in the first signal corresponding to stored identification information; and display, through the display, a second screen indicating the first wearable device, based on not receiving a beacon signal from the first wearable device through the first communication circuitry for a specified period after displaying the first screen.

According to an example embodiment, the first wearable device may be configured to transmit the beacon signal while the first wearable device is not worn by a user. The first wearable device may be configured to refrain from transmitting the beacon signal while the first wearable device is worn by the user.

According to an example embodiment, a method of operating the electronic device may include: performing a scan for discovering an external device through a first communication scheme; based on receiving of a signal from the first wearable device, based on the scan; receiving, from the first wearable device through the first communication scheme, a first signal including identification information corresponding to the first wearable device; displaying a first screen including a message for guiding of wearing of the first wearable device, based on the identification information included in the first signal corresponding to stored identification information; and displaying a second screen indicating the first wearable device, based on not receiving a beacon signal from the first wearable device through the first communication scheme for a specified period after displaying the first screen.

According to an example embodiment, the first wearable device may be configured to transmit the beacon signal while the first wearable device is not worn by a user. The first wearable device may be configured to refrain from transmitting the beacon signal while the first wearable device is worn by the user.

According to an example embodiment, a non-transitory computer-readable recording medium storing instructions, which when executed by at least one processor, individually and/or collectively, cause at least one operation to be performed by an electronic device, the at least one operation may comprise: performing a scan for discovering an external device through a first communication scheme; identifying a first wearable device, based on receiving of a signal from the first wearable device, based on the scan; receiving, from the first wearable device through the first communication scheme, a first signal including identification information corresponding to the first wearable device; displaying a first screen including a message for guiding of wearing of the first wearable device, based on the identification information included in the first signal corresponding to stored identification information; and displaying a second screen indicating the first wearable device, based on not receiving a beacon signal from the first wearable device through the first communication scheme for a specified period after displaying the first screen.

According to an example embodiment, the first wearable device may be configured to transmit the beacon signal while the first wearable device is not worn by a user. The first wearable device may be configured to refrain from transmitting the beacon signal while the first wearable device is worn by the user.

According to an example embodiment, an electronic device may include: memory configured to store a program including instructions, first communication circuitry configured to support a first communication scheme, second communication circuitry configured to support a second communication scheme, a display, and at least one controller comprising at least one processor, comprising processing circuitry, wherein the instructions may, when executed by at least one processor, individually and/or collectively, cause the electronic device to: receive, from a first wearable device through the first communication circuitry, a signal including identification information corresponding to the first wearable device; store the identification information corresponding to the first wearable device 210 in the memory; identify custom information corresponding to the first wearable device, based on a user input; transmit, to the first wearable device through the first communication circuitry, a signal including the custom information; in a state in which communication of the first communication scheme between the electronic device and the first wearable device is not established, perform a scan for discovering an external device through the first communication; identify a plurality of external devices including the first wearable device, based on receiving of signals from the plurality of external devices, based on the scan; based on identifying the plurality of external devices, receive, from the first wearable device through the second communication circuitry 302a first signal including the identification information and the custom information corresponding to the first wearable device; display, through the display, a first screen indicating the first wearable device, based on the identification information included in the first signal corresponding to the identification information stored in the memory. The first screen may include the custom information corresponding to the first wearable device.

According to an example embodiment, the instructions may, when executed by at least processor, individually and/or collectively, cause the electronic device to, in a state in which the first signal has not been received from the first wearable device, receive, from a second wearable device through the second communication circuitry, a second signal including identification information and custom information; display, through the display 160a second screen indicating another external device distinct from the first wearable device, based on the identification information included in the second signal not corresponding to the identification information stored in the memory, wherein the second screen may include the custom information corresponding to the second wearable device.

According to an example embodiment, a method of operating an electronic device may include: receiving, from a first wearable device through a first communication scheme, a signal including identification information corresponding to the first wearable device; storing the identification information corresponding to the first wearable device; identifying custom information corresponding to the first wearable device, based on an input; transmitting a signal including the custom information to the first wearable device through the first communication scheme; in a state in which communication of the first communication scheme between the electronic device and the first wearable device is not established, performing a scan for discovering an external device through the first communication scheme; identifying a plurality of external devices including the first wearable device, based on receiving of signals from the plurality of external devices, based on the scan; based on identifying the plurality of external devices, receiving, from the first wearable device through a second communication scheme, a first signal including the identification information and the custom information corresponding to the first wearable device; and displaying a first screen indicating the first wearable device, based on the identification information included in the first signal corresponding to the identification information stored in the memory, wherein the first screen may include the custom information corresponding to the first wearable device.

According to an example embodiment, the method may include: in a state in which the first signal has not been received from the first wearable device, receiving, from a second wearable device through the second communication scheme, a second signal including identification information and custom information; and displaying a second screen indicating another external device distinct from the first wearable device, based on the identification information included in the second signal not corresponding to the stored identification information, wherein the second screen may include the custom information corresponding to the second wearable device.

According to an example embodiment, a non-transitory computer-readable recording medium storing instructions, which when executed by at least one processor, individually and/or collectively, cause an electronic device to perform at least one operation, the at least one operation may include: receiving, from a first wearable device through a first communication scheme, a signal including identification information corresponding to the first wearable device; storing the identification information corresponding to the first wearable device; identifying custom information corresponding to the first wearable device, based on an input; transmitting a signal including the custom information to the first wearable device through the first communication; in a state in which communication of the first communication scheme between the electronic device and the first wearable device is not established, performing a scan for discovering an external device through the first communication scheme; identifying a plurality of external devices including the first wearable device, based on receiving of signals from the plurality of external devices, based on the scan; based on identifying the plurality of external devices, receiving, from the first wearable device through a second communication scheme, a first signal including the identification information and the custom information corresponding to the first wearable device; and displaying a first screen indicating the first wearable device, based on the identification information included in the first signal corresponding to the identification information stored in the memory, wherein the first screen may include the custom information corresponding to the first wearable device 210.

According to an example embodiment, the at least one operation may include: in a state in which the first signal has not been received from the first wearable device, receiving, from a second wearable device through the second communication scheme, a second signal including identification information and custom information; and displaying a second screen indicating another external device distinct from the first wearable device, based on the identification information included in the second signal not corresponding to the stored identification information, wherein the second screen may include the custom information corresponding to the second wearable device.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage that is readable by a machine (e.g., the electronic device). For example, a processor (e.g., the controller) of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In I such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
memory storing a program including instructions;
first communication circuitry configured to support a first communication scheme;
second communication circuitry configured to support a second communication scheme;
a display; and
at least one controller comprising at least one processor, comprising processing circuitry,
wherein the instructions, when executed by at least processor, individually and/or collectively, cause the electronic device to:
perform a scan for discovering an external device through the first communication circuitry,
identify a plurality of external devices including a first wearable device, based on receiving signals from the plurality of external devices, based on the scan,
based on identifying the plurality of external devices, receive, from the first wearable device through the second communication circuitry, a first signal including identification information corresponding to the first wearable device, and
display, through the display, a first screen indicating the first wearable device, based on the identification information included in the first signal corresponding to stored identification information.

2. The electronic device of claim 1, wherein the instructions, when executed by at least one processor, individually and/or collectively, cause the electronic device to:
before performing the scan, receive, from the first wearable device through the first communication circuitry, a signal including the identification information corresponding to the first wearable device, and
based on the signal, store the identification information corresponding to the first wearable device in the memory,
wherein the stored identification information includes the identification information corresponding to the first wearable device stored in the memory.

3. The electronic device of claim 1, wherein the instructions, when executed by at least one processor, individually and/or collectively, cause the electronic device to:
before receiving the first signal, display, through the display, a second screen including a message for guiding tapping, based on identifying the plurality of external devices.

4. The electronic device of claim 3, wherein the electronic device is configured to transmit the first signal, based on the tapping of the first wearable device on the electronic device.

5. The electronic device of claim 1, wherein the instructions, when executed by at least one processor, individually and/or collectively, cause the electronic device to:
in a state in which the first signal has not been received from the first wearable device, receive, from the first wearable device through the first communication circuitry, a second signal indicating occurrence of tapping of the first wearable device, and
based on the second signal, display, through the display, a third screen indicating tapping of the first wearable device on another external device.

6. The electronic device of claim 2, wherein the instructions, when executed by at least one processor, individually and/or collectively, cause the electronic device to:
before performing the scan, identify custom information corresponding to the first wearable device, based on an input, and
store, in the memory, information in which the custom information and the identification information are mapped, and
wherein the first screen includes the custom information corresponding to the first wearable device.

7. The electronic device of claim 1, wherein the instructions, when executed by at least one processor, individually and/or collectively, cause the electronic device to:
in a state in which the first signal has not been received from the first wearable device, receive, from a second wearable device through the second communication circuitry, a third signal including identification information corresponding to the second wearable device, and
display, through the display, a fourth screen indicating another external device distinct from the first wearable device, based on the identification information included in the third signal not corresponding to the stored identification information.

8. The electronic device of claim 1, wherein the instructions, when executed by at least one processor, individually and/or collectively, cause the electronic device to transmit a first control signal to the first wearable device through the first communication circuitry, before performing the scan for discovering the external device, and
wherein the first wearable device is configured to, based on the first control signal, transmit an advertisement signal of the first communication scheme and start a service of the second communication scheme.

9. The electronic device of claim 8, wherein the first wearable device is configured to transmit the advertisement signal of the first communication scheme and start the service of the second communication scheme, based on satisfaction of a specified condition while not receiving the first control signal.

10. The electronic device of claim 1, wherein the instructions, when executed by at least one processor, individually and/or collectively, cause the electronic device to transmit, to the first wearable device through the first communication circuitry, a second control signal causing generation of a notification of the first wearable device, and
wherein the first wearable device is configured to generate the notification corresponding to the second control signal.

11. The electronic device of claim 1, wherein the first wearable device is configured to transmit, to the electronic device, information about a wearing state of the first wearable device, and
wherein the instructions, when executed by at least one processor, individually and/or collectively, cause the electronic device to display, through the display, a fifth screen including the wearing state, based on the information about the wearing state.

12. The electronic device of claim 1, wherein the first wearable device comprises a smart ring.

13. A method of operating an electronic device, comprising:
performing a scan for discovering an external device through a first communication scheme;
identifying a plurality of external devices including a first wearable device, based on receiving of signals from the plurality of external devices, based on the scan;
based on identifying the plurality of external devices, receiving, from the first wearable device through a second communication scheme, a first signal including identification information corresponding to the first wearable device; and
displaying a first screen indicating the first wearable device, based on the identification information included in the first signal corresponding to stored identification information.

14. The method of claim 13, further comprising, before receiving the first signal, displaying a second screen including a message for guiding tapping, based on identifying the plurality of external devices.

15. The method of claim 14, wherein the first signal is transmitted, based on the tapping of the first wearable device on the electronic device.

16. A non-transitory computer-readable recording medium storing instructions which, when executed by at least one processor, individually and/or collectively, cause at least one operation to be performed by an electronic device,
wherein the at least one operation comprises:
performing a scan for discovering an external device through a first communication scheme;
identifying a plurality of external devices including a first wearable device, based on receiving of signals from the plurality of external devices, based on the scan;
based on identifying the plurality of external devices, receiving, from the first wearable device through a second communication scheme, a first signal including identification information corresponding to the first wearable device; and
displaying a first screen indicating the first wearable device, based on the identification information included in the first signal corresponding to stored identification information.

17. An electronic device comprising:
memory storing a program including instructions;
first communication circuitry configured to support a first communication scheme;
second communication circuitry configured to support a second communication scheme;
a display; and
at least one controller comprising at least one processor, comprising processing circuitry,
wherein the instructions, when executed by at least one processor, individually and/or collectively, cause the electronic device to:
perform a scan for discovering an external device through the first communication circuitry,
identify a first wearable device, based on receiving a signal from the first wearable device, based on the scan,
receive, from the first wearable device through the first communication circuitry, a first signal including identification information corresponding to the first wearable device,
display, through the display, a first screen including a message for guiding wearing of the first wearable device, based on the identification information included in the first signal corresponding to stored identification information, and
display, through the display, a second screen indicating the first wearable device, based on not receiving a beacon signal from the first wearable device through the first communication module for a specified period after displaying the first screen.

18. The electronic device of claim 17, wherein the first wearable device is configured to:
transmit the beacon signal while the first wearable device is not worn by a user, and
refrain from transmitting the beacon signal while the first wearable device is worn by the user.

19. An electronic device comprising:
memory storing a program including instructions;
first communication circuitry configured to support a first communication scheme;
second communication circuitry configured to support a second communication scheme;
a display; and
at least one controller comprising at least one processor, comprising processing circuitry,
wherein the instructions, when executed by at least one processor, individually and/or collectively, cause the electronic device to:
receive, from a first wearable device through the first communication circuitry, a signal including identification information corresponding to the first wearable device,
store the identification information corresponding to the first wearable device in the memory,
identify custom information corresponding to the first wearable device, based on an input,
transmit, to the first wearable device through the first communication circuitry, a signal including the custom information,
in a state in which communication of the first communication scheme between the electronic device and the first wearable device is not established, perform a scan for discovering an external device through the first communication circuitry,
identify a plurality of external devices including the first wearable device, based on receiving signals from the plurality of external devices, based on the scan,
based on identifying the plurality of external devices, receive, from the first wearable device through the second communication circuitry, a first signal including the identification information and the custom information corresponding to the first wearable device, and
display, through the display, a first screen indicating the first wearable device, based on the identification information included in the first signal corresponding to the identification information stored in the memory, and
wherein the first screen includes the first custom information corresponding to the first wearable device.

20. The electronic device of claim 19, wherein the instructions, when executed by at least one processor, individually and/or collectively, cause the electronic device to:
in a state in which the first signal has not been received from the first wearable device, receive, from a second wearable device through the second communication circuitry, a second signal including identification information and custom information, and
display, through the display, a second screen indicating another external device distinct from the first wearable device, based on the identification information included in the second signal not corresponding to the identification information stored in the memory, and
wherein the second screen includes the custom information corresponding to the second wearable device.
